(19) United States
(12) Patent Application Publication
(10) Pub. No.: US 2021/0089531 A1
(43) Pub. Date: Mar. 25, 2021

(54) SYSTEMS AND METHODS FOR PROCESSING QUERIES

(71) Applicant: BEIJING DIDI INFINITY TECHNOLOGY AND DEVELOPMENT CO., LTD, Beijing (CN)

(72) Inventors: Juan HU, Beijing (CN); Huan CHEN, Beijing (CN); Qi SONG, Beijing (CN)

(73) Assignee: BEIJING DIDI INFINITY TECHNOLOGY AND DEVELOPMENT CO., LTD., Beijing (CN)

(21) Appl. No.: 17/093,664

(22) Filed: Nov. 10, 2020

Related U.S. Application Data
(63) Continuation of application No. PCT/CN2019/081444, filed on Apr. 4, 2019.

(30) Foreign Application Priority Data
Jun. 1, 2018 (CN) 201810554080.3
Jun. 27, 2018 (CN) 201810678790.7

(51) Int. Cl. G06F 16/2453; G06F 16/242; G06F 16/248

(52) U.S. Cl. CPC G06F 16/24539; G06F 16/248; G06F 16/2425

(57) ABSTRACT

Query processing methods and systems are provided. The query processing method may include receiving an original query and segmenting the original query into one or more original phrases to obtain a phrase sequence. In some cases, the method may include segmenting the original query based on a phrase list. The phrase list may include a plurality of existing phrases. Further, for each original phrase, the method may also include determining one or more candidate phrases. Each candidate phrase may correspond to a probability. The method may also include determining a rewritten phrase based on the one or more candidate phrases, the corresponding probabilities, and a predetermined threshold probability. Further, the method may include generating a rewritten query corresponding to the original query based on the rewritten phrases and the phrase sequence.

### CROSS-REFERENCE TO RELATED APPLICATION

This application is a continuation of International Patent Application No. PCT/CN2019/081444, filed on Apr. 4, 2019, which claims priority to Chinese Patent Application No. 201810678790.7, filed on Jun. 27, 2018, and Chinese Patent Application No. 201810554080.3, filed on Jun. 1, 2018, the contents of each of which are hereby incorporated by reference.

### TECHNICAL FIELD

The present disclosure generally relates to systems and methods for processing a query, and specifically, to systems and methods for segmenting the query based on a phrase list (e.g., a Point of Interest (POI) list) and/or rewriting the query before searching.

### BACKGROUND

Generally, a user inputs a query and a search platform determines a search result associated with the query. In an ideal scenario, the search result would match the user's intent. However, in some searches, such is not the case for various reasons. For example, the query input by the user may be incorrect, e.g., the user misspells the query. As another example, the search platform may segment the query incorrectly and then obtain the search result based on the wrong segmentation. In certain occasions, the segmenting result is not optimal for the query (i.e. not reflecting the user's intent) because the search platform conducts the segmentation without considering specific information associated with the query, specific information such as application scenario of the query, user habit of using phrases, etc. For illustration, the search platform segments the query based on a general list (e.g., a phrase dictionary, a corpus), however, without considering the application scenario of the query: transportation. It would be probable that the search result is only marginally related to transportation since the general list likely includes phrases in a number of application scenarios, with transportation being only a small portion. Therefore, it is desirable to provide systems and method for processing a query to determine an optimal search result associated with the query.

### SUMMARY

According to a first aspect of the present disclosure, a system for rewriting a query is provided. The system may include at least one storage medium including a set of instructions; and at least one processor in communication with the at least one storage medium. When executing the set of instructions, the at least one processor may be directed to: receive an original query of a user from a user terminal; segment the original query into one or more original phrases to obtain a phrase sequence; for each original phrase, determine one or more candidate phrases, each candidate phrase corresponding to a probability; for each original phrase, determine a rewritten phrase based on the one or more candidate phrases, the corresponding probabilities, and a predetermined threshold probability; and generate a rewritten query corresponding to the original query based on the rewritten phrases and the phrase sequence.

In some embodiments, the phrase sequence may include a first original phrase, a second original phrase, . . . , a (j−1)^{th} original phrase, a j^{th} original phrase, . . . , and an N^{th} original phrase. Wherein to determine the one or more candidate phrases and to determine the rewritten phrase, the at least one processor may be further directed to: initiate an iteration process for determining the one or more candidate phrases and determining the rewritten phrase, the iteration process including (N−1) iterations, and each iteration in the iteration process including: determining one or more (j−1)^{th} candidate phrases for the (j−1)^{th} original phrase and one or more (j−1)^{th} probabilities corresponding to the one or more (j−1)^{th} candidate phrases; determining a (j−1)^{th} rewritten phrase with a probability greater than the predetermined threshold probability; determining one or more j^{th} candidate phrases for the ^{jth} original phrase and one or more j^{th} probabilities corresponding to the one or more j^{th} candidate phrases based on the (j−1)^{th} rewritten phrase; and determining a j^{th} rewritten phrase with a probability greater than the predetermined threshold probability.

In some embodiments, the processor may be directed to use a query processing model to determine the one or more candidate phrases and to determine the rewritten phrase, and the query processing model may be provided by: obtaining a plurality of first historical search records, wherein each of the plurality of first historical search records may include a first historical query of a first historical user and a first historical search result selected by the first historical user corresponding to the first historical query; segmenting each of the plurality of first historical search records; and training a preliminary query processing model based on the plurality of segmented first historical search records to generate the query processing model.

In some embodiments, the at least one processor may determine the predetermined threshold probability by: obtaining a plurality of second historical search records, wherein each of the plurality of second historical search records may include a second historical query of a second historical user and a second historical search result selected by the second historical user corresponding to the second historical query; for each of the plurality of second historical search records, obtaining a combination of actual phrases of the second historical record, wherein the combination of the actual phrases may include one or more actual phrases; determining one or more predicted phrases of each of the one or more actual phrases and one or more predicted probabilities corresponding to the one or more predicted phrases based on the query processing model; and determining the predetermined threshold probability based on similarity between the actual phrases and the predicted phrases of each of the plurality of second historical records.

In some embodiments, the query processing model may include sequence to sequence learning model including attention mechanism.

According to a second aspect of the present disclosure, a method for rewriting a query is provided. The method may be implemented on a computing device having at least one processor, at least one storage medium, and a communication platform connected to a network. The method may include: receiving an original query of a user from a user terminal; segmenting the original query into one or more original phrases to obtain a phrase sequence; for each original phrase, determining one or more candidate phrases, each candidate phrase corresponding to a probability; for each original phrase, determining a rewritten phrase based on the one or more candidate phrases, the corresponding probabilities, and a predetermined threshold probability; and generating a rewritten query corresponding to the original query based on the rewritten phrases and the phrase sequence.

In some embodiments, the phrase sequence may include a first original phrase, a second original phrase, . . . , a (j−1)^{th} original phrase, a j^{th} original phrase, . . . , and an N^{th} original phrase. Wherein the determining the one or more candidate phrases and the determining the rewritten phrase, the method may further include: initiating an iteration process for determining the one or more candidate phrases and determining the rewritten phrase, the iteration process including (N−1) iterations, and each iteration in the iteration process including: determining one or more (j−1)^{th} candidate phrases for the (j−1)^{th} original phrase and one or more (j−1)^{th} probabilities corresponding to the one or more (j−1)^{th} candidate phrases; determining a (j−1)^{th} rewritten phrase with a probability greater than the predetermined threshold probability; determining one or more j^{th} candidate phrases for the j^{th} original phrase and one or more j^{th} probabilities corresponding to the one or more j^{th} candidate phrases based on the (j−1)^{th} rewritten phrase; and determining a j^{th} rewritten phrase with a probability greater than the predetermined threshold probability.

In some embodiments, a query processing model may be used for determining the one or more candidate phrases and determining the rewritten phrase and the query processing model may be provided by: obtaining a plurality of first historical search records, wherein each of the plurality of first historical search records may include a first historical query of a first historical user and a first historical search result selected by the first historical user corresponding to the first historical query; segmenting each of the plurality of first historical search records; and training a preliminary query processing model based on the plurality of segmented first historical search records to generate the query processing model.

In some embodiments, the predetermined threshold probability is determined by: obtaining a plurality of second historical search records, wherein each of the plurality of second historical search records may include a second historical query of a second historical user and a second historical search result selected by the second historical user corresponding to the second historical query; for each of the plurality of second historical search records, obtaining a combination of actual phrases of the second historical record, wherein the combination of the actual phrases may include one or more actual phrases; determining one or more predicted phrases of each of the one or more actual phrases and one or more predicted probabilities corresponding to the one or more predicted phrases based on the query processing model; and determining the predetermined threshold probability based on similarity between the actual phrases and the predicted phrases of each of the plurality of second historical records.

In some embodiments, the query processing model may include sequence to sequence learning model including attention mechanism.

According to a third aspect of the present disclosure, a system for retrieving a query is provided. The system may include at least one storage medium including a set of instructions; and at least one processor in communication with the at least one storage medium. When executing the set of instructions, the at least one processor may be directed to: obtain a query of a user from a user terminal; segment the query into one or more phrases based on a phrase list; wherein the phrase list may include a plurality of existing phrases, and perform a search based on the one or more phrases to obtain a search result associated with the query.

In some embodiments, wherein to segment the query into one or more phrases, the at least one processor may be further directed to: segment the query into the one or more phrases using a coarse-grained segmenting mode or a fine-grained segmenting mode based on the phrase list.

In some embodiments, the at least one processor may generate the phrase list by: obtaining a plurality of first historical search records, wherein each of the first historical search records at least may include a first historical query of a first historical user; segmenting each of the plurality of first historical search records based on a phrase dictionary; and determining the phrase list based on the segmented first historical search records.

In some embodiments, the at least one processor may be further directed to: initiate an iteration process for determining the phrase list, the iteration process including a plurality of iterations, and each iteration in the iteration process including: segmenting one first historical search record of the plurality of first historical search records based on the phrase dictionary; adding the segmented first historical search record to the phrase dictionary to generate a new phrase dictionary in response to a determination that the segmented first historical search record satisfies a predetermined condition; and segmenting another first historical search record of the plurality of first historical search records based on the new phrase dictionary.

In some embodiments, the at least one processor may be further directed to: obtain a plurality of second historical search records, wherein each of the plurality of second historical search records may include a second historical query of a second historical user or a second historical search result selected by the second historical user corresponding to the second historical search record; segment each of the plurality of second historical search records; determine feature information of each of the plurality of segmented second historical search records; and add at least one phrase among the plurality of segmented second historical search records into the phrase list based on the feature information.

In some embodiments, the feature information may include at least one of: a cohesive parameter between two phrases in the segmented second historical search record, a degree of freedom of a phrase in the segmented second historical search record, and a habit of the user.

In some embodiments, wherein to perform a search based on the one or more phrases to obtain a search result associated with the query, the at least one processor may be further directed to: rewrite the query based on a query processing model, wherein the query processing model may be provided by: obtaining a plurality of third historical search records, wherein each of the plurality of third historical search records may include a third historical query of a third historical user and a third historical search result selected by the third historical user corresponding to the third historical query; segmenting each of the plurality of third historical search records; and training a preliminary query processing model based on the plurality of third segmented historical search records to generate the query processing model.

According to a fourth aspect of the present disclosure, a method for retrieving a query is provided. The method may be implemented on a computing device having at least one processor, at least one storage medium, and a communication platform connected to a network. The method may include: obtaining a query of a user from a user terminal; segmenting the query into one or more phrases based on a phrase list; wherein the phrase list may include a plurality of existing phrases, and performing a search based on the one or more phrases to obtain a search result associated with the query.

In some embodiments, wherein the segmenting the query into one or more phrases, the method may further include: segmenting the query into the one or more phrases using a coarse-grained segmenting mode or a fine-grained segmenting mode based on the phrase list.

In some embodiments, wherein the phrase list may be generated by: obtaining a plurality of first historical search records, wherein each of the first historical search records at least may include a first historical query of a first historical user; segmenting each of the plurality of first historical search records based on a phrase dictionary; and determining the phrase list based on the segmented first historical search records.

In some embodiments, the method may further include: initiating an iteration process for determining the phrase list, the iteration process including a plurality of iterations, and each iteration in the iteration process including: segmenting one first historical search record of the plurality of first historical search records based on the phrase dictionary; adding the segmented first historical search record to the phrase dictionary to generate a new phrase dictionary in response to a determination that the segmented first historical search record satisfies a predetermined condition; and segmenting another first historical search record of the plurality of first historical search records based on the new phrase dictionary.

In some embodiments, the method may further include: obtaining a plurality of second historical search records, wherein each of the plurality of second historical search records may include a second historical query of a second historical user or a second historical search result selected by the second historical user corresponding to the second historical search record; segmenting each of the plurality of second historical search records; determining feature information of each of the plurality of segmented second historical search records; and adding at least one phrase among the plurality of segmented second historical search records into the phrase list based on the feature information.

In some embodiments, the feature information may include at least one of: a cohesive parameter between two phrases in the segmented second historical search record, a degree of freedom of a phrase in the segmented second historical search record, and a habit of the user.

In some embodiments, wherein the performing a search based on the one or more phrases to obtain a search result associated with the query, the method may further include: rewriting the query based on a query processing model, wherein the query processing model may be provided by: obtaining a plurality of third historical search records, wherein each of the plurality of third historical search records may include a third historical query of a third historical user and a third historical search result selected by the third historical user corresponding to the third historical query; segmenting each of the plurality of third historical search records; and training a preliminary query processing model based on the plurality of third segmented historical search records to generate the query processing model.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary query processing system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4 is a block diagram illustrating an exemplary processing engine according to some embodiments of the present disclosure;

FIG. 5 is a flowchart illustrating an exemplary process for rewriting an original query according to some embodiments of the present disclosure;

FIG. 6 is a flowchart illustrating an exemplary process for determining a query processing model according to some embodiments of the present disclosure;

FIG. 7 is a flowchart illustrating an exemplary process for determining a predetermined threshold probability according to some embodiments of the present disclosure;

FIG. 8 is a flowchart illustrating an exemplary process for performing a search of a query based on a phrase list according to some embodiments of the present disclosure;

FIG. 9 is a flowchart illustrating an exemplary process for generating a phrase list according to some embodiments of the present disclosure

FIG. 10 is a flowchart illustrating an exemplary process for supplementing a phrase list according to some embodiments of the present disclosure;

FIG. 11 is a flowchart illustrating an exemplary process for processing a text according to some embodiments of the present disclosure;

FIG. 12 is a flowchart illustrating an exemplary process for determining a text processing model according to some embodiments of the present disclosure;

FIG. 13 is a block diagram illustrating an exemplary query processing device according to some embodiments of the present disclosure;

FIG. 14 is a flowchart illustrating an exemplary process for probability truncation according to some embodiments of the present disclosure;

FIG. 15 is a block diagram illustrating an exemplary semantic retrieval device according to some embodiments of the present disclosure;

FIG. 16 is a flowchart illustrating an exemplary process for searching a query according to some embodiments of the present disclosure;

FIG. 17 is a block diagram illustrating an exemplary segmenting device according to some embodiments of the present disclosure; and

FIG. 18 is a flowchart illustrating an exemplary process for determining a phrase list according to some embodiments of the present disclosure.

### DETAILED DESCRIPTION

The following description is presented to enable any person skilled in the art to make and use the present disclosure and is provided in the context of a specific application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing specific example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

An aspect of the present disclosure relates to systems for rewriting a query. The system may receive an original query of a user from a user terminal. The system may also segment the original query into one or more original phrases to obtain a phrase sequence. In some cases, the original query may be incorrect and may not represent what the user wants to search. The system may rewrite the original query. Specifically, for each original phrase, the system may determine one or more candidate phrases. Each candidate phrase may correspond to a probability. Further, the system may determine a rewritten phrase based on the one or more candidate phrases, the corresponding probabilities, and a predetermined threshold probability for each original phrase. The system may rewrite the original query based on the rewritten phrases and the phrase sequence. In this disclosure, the system may rewrite the original query based on a query processing model. The query processing model may be configured to determine one or more candidate phrases and corresponding probabilities for an original phrase. The query processing model may also determine a rewritten phrase corresponding to the original phrase.

A second aspect of the present disclosure relates to systems for retrieving a query. The system may segment a query of a user based on a phrase list. The phrase list may include a plurality of existing phrases, e.g., associated with a specific application scenario. For example, the phrase list may include a Point of Interest (POI) phrase list. The phrase list may also include a plurality of sub lists, and each of the sub lists may be associated with a specific application scenario. The system may perform a search based on the segmented query. In some cases, before performing search, the system may automatically determine whether the query is incorrect. In response to a determination that the query is incorrect, the system may also rewrite the query e.g., based on the process described above.

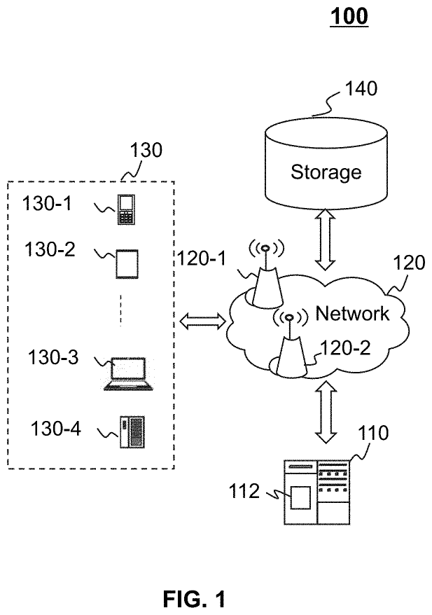

FIG. 1 is a schematic diagram illustrating an exemplary query processing system according to some embodiments of the present disclosure. For example, the query processing system 100 may be an online search platform for services, e.g., a transportation service, an online shopping service, a map (e.g., GOOGLE Map, BAIDU Map, TENCENT Map) navigation service, a meal ordering service, etc. The query processing system 100 may include a server 110, a network 120, a user terminal 130, and a storage 140.

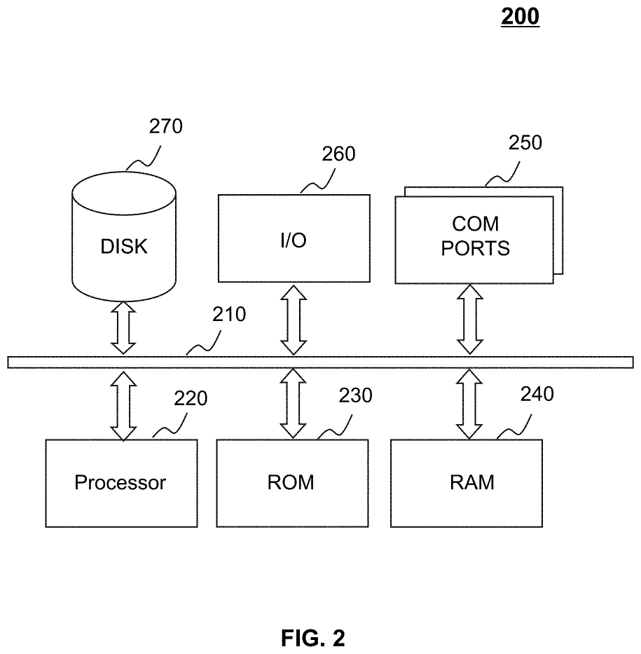

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the user terminal 130 and/or the storage 140 via the network 120. As another example, the server 110 may be directly connected to the user terminal 130 and/or the storage 140 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2.

In some embodiments, the server 110 may include a processing engine 112. The processing engine 112 may process information and/or data to perform one or more functions described in the present disclosure. For example, the processing engine 112 may rewrite an incorrect query based on a query processing model. As another example, the processing engine 112 may segment a query based a phrase list (e.g., a POI phrase list). In some embodiments, the processing engine 112 may include one or more processing engines (e.g., single-core processing engine(s) or multi-core processor(s)). The processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the query processing system 100 (e.g., the server 110, the user terminal 130, or the storage 140) may transmit information and/or data to other component(s) of the query processing system 100 via the network 120. For example, the server 110 may obtain a query from the user terminal 130 via the network 120. In some embodiments, the network 120 may be any type of wired or wireless network, or any combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the query processing system 100 may be connected to the network 120 to exchange data and/or information.

In some embodiments, the user terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an expanded reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the expanded reality device may include a virtual reality helmet, a virtual reality glass, a virtual reality patch, an expanded reality helmet, an expanded reality glass, an expanded reality patch, or the like, or any combination thereof. For example, the virtual reality device and/or the expanded reality device may include a Google Glass™ an Oculus Rift™, a Hololens™, a Gear VR™, etc. In some embodiments, a built-in device in the vehicle 130-4 may include an onboard computer, an onboard television, etc.

The storage 140 may store data and/or instructions relating to the query. In some embodiments, the storage 140 may store data obtained from the user terminal 130. In some embodiments, the storage 140 may store data and/or instructions that the server 110 may execute or use to perform exemplary methods described in the present disclosure. In some embodiments, the storage 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 140 may be connected to the network 120 to communicate with one or more components of the query processing system 100 (e.g., the server 110, the user terminal 130). One or more components of the query processing system 100 may access the data and/or instructions stored in the storage 140 via the network 120. In some embodiments, the storage 140 may be directly connected to or communicate with one or more components of the query processing system 100 (e.g., the server 110, the user terminal 130). In some embodiments, the storage 140 may be part of the server 110.

In some embodiments, one or more components of the query processing system 100 (e.g., the server 110, the user terminal 130) may have permissions to access the storage 140. In some embodiments, one or more components of the query processing system 100 may read and/or modify information relating to the query and/or the public when one or more conditions are met.

In some embodiments, information exchanging of one or more components of the query processing system 100 may be achieved by way of requesting a search service. The object of the search request may be any product. In some embodiments, the product may be a tangible product or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle), a car (e.g., a taxi, a bus, a private car), a train, a subway, a vessel, an aircraft (e.g., an airplane, a helicopter, a space shuttle, a rocket, a hot-air balloon), or the like, or any combination thereof.

One of ordinary skill in the art would understand that when an element (or component) of the query processing system 100 performs, the element may perform through electrical signals and/or electromagnetic signals. For example, when the user terminal 130 transmits out a query to the server 110, a processor of the user terminal 130 may generate an electrical signal encoding the query. The processor of the user terminal 130 may then transmit the electrical signal to an output port. If the user terminal 130 communicates with the server 110 via a wired network, the output port may be physically connected to a cable, which further may transmit the electrical signal to an input port of the server 110. If the user terminal 130 communicates with the server 110 via a wireless network, the output port of the user terminal 130 may be one or more antennas, which convert the electrical signal to electromagnetic signal. Within an electronic device, such as the user terminal 130 and/or the server 110, when a processor thereof processes an instruction, transmits out an instruction, and/or performs an action, the instruction and/or action is conducted via electrical signals. For example, when the processor retrieves or saves data from a storage medium (e.g., the storage 140), it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and/or software components of a computing device 200 according to some embodiments of the present disclosure. In some embodiments, the server 110 and/or the user terminal 130 may be implemented on the computing device 200. For example, the processing engine 112 may be implemented on the computing device 200 and configured to perform functions of the processing engine 112 disclosed in this disclosure.

The computing device 200 may be used to implement any component of the query processing system 100 as described herein. For example, the processing engine 112 may be implemented on the computing device 200, via its hardware, software program, firmware, or a combination thereof. Although only one such computer is shown, for convenience, the computer functions relating to the search service as described herein may be implemented in a distributed fashion on a number of similar platforms to distribute the processing load.

The computing device 200, for example, may include COM ports 250 connected to and from a network connected thereto to facilitate data communications. The computing device 200 may also include a processor 220, in the form of one or more processors (e.g., logic circuits), for executing program instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage of different forms including, for example, a disk 270, and a read only memory (ROM) 230, or a random access memory (RAM) 240, for various data files to be processed and/or transmitted by the computing device. The exemplary computer platform may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one processor is described in FIG. 2. Multiple processors are also contemplated, thus operations and/or method steps performed by one processor as described in the present disclosure may also be jointly or separately performed by the multiple processors. For example, if in the present disclosure the processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

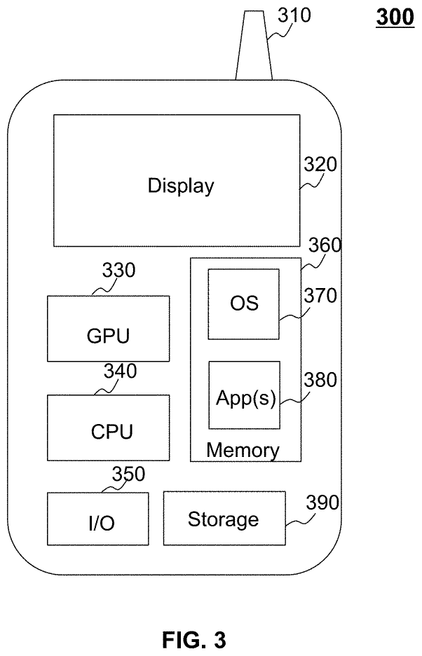

FIG. 3 is a schematic diagram illustrating exemplary hardware and/or software components of a mobile device 300 on which the user terminal 130 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, a mobile operating system (OS) 370, and a storage 390. In some embodiments, any other suitable component, including but not limited to a system bus or a controller (not shown), may also be included in the mobile device 300.

In some embodiments, the mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to search services or other information from the query processing system 100. User interactions with the information stream may be achieved via the I/O 350 and provided to the processing engine 112 and/or other components of the query processing system 100 via the network 120.

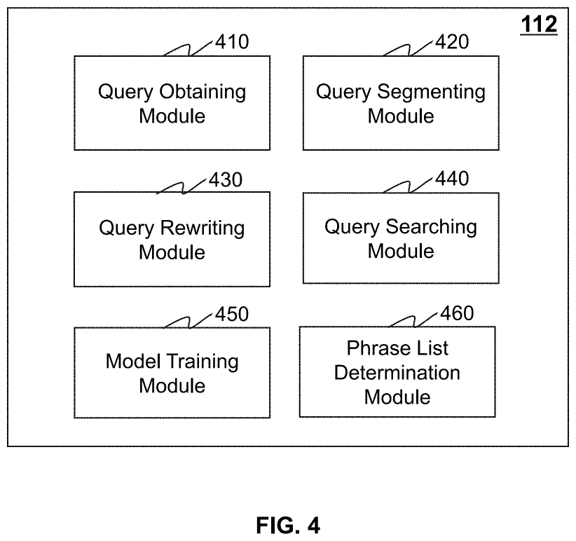

FIG. 4 is a block diagram illustrating an exemplary processing engine according to some embodiments of the present disclosure. The processing engine 112 may include a query obtaining module 410, a query segmenting module 420, a query rewriting module 430, a query searching module 440, a model training module 450, and a phrase list determination module 460.

The query obtaining module 410 may be configured to obtain a search query. The search query may include an original query, a query, an input text, or a text described below. In some embodiments, the search query may refer to a term that the user intends to search, and the search query may be used for further search. In some embodiments, the search query may be incorrect to represent what the user intends to search. In some embodiments, the user may misspell the search query. In some embodiments, the user may use a wrong word, i.e., semantic information of the search query may be not identical with what the user intends to search. In some embodiments, the search query may be incomplete or ambiguous, and the search query may not represent what the user intends to search actually.

The query segmenting module 420 may be configured to segment the search query and obtain a phrase sequence. As used herein, the phrase sequence may include the one or more phrases arranged in a position sequence according to the search query. For example, if the search query is ABC, and the one or more phrases include Phrase A, Phrase B, and Phrase C, the phrase sequence may be (Phrase A, phrase B, and Phrase C).

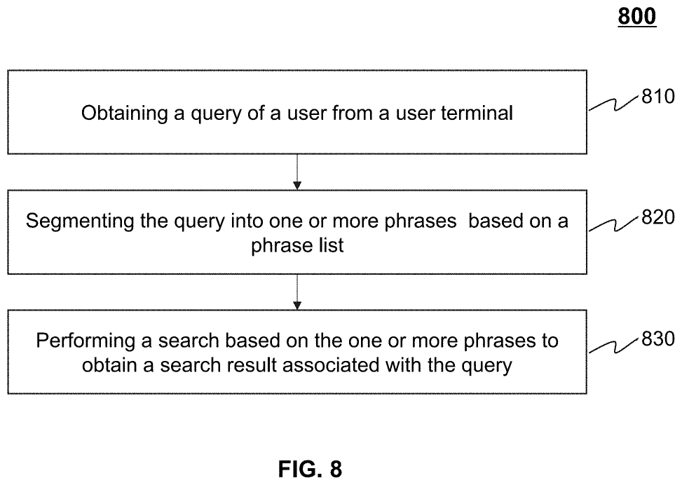

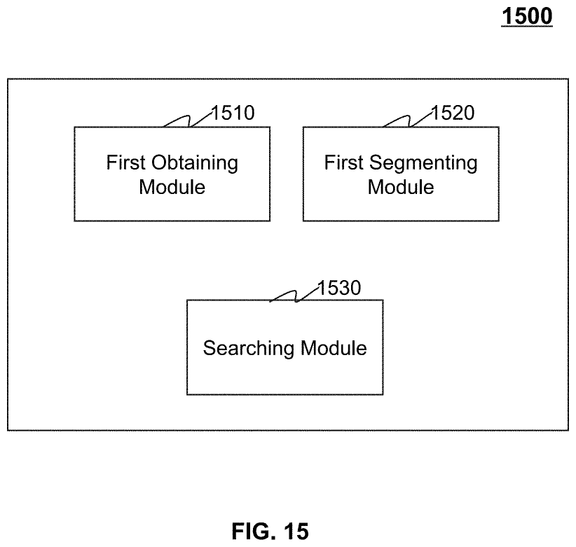

In some embodiments, the query segmenting module 420 may segment the query based on a segmenting technique, a phrase list. (e.g., a phrase list illustrated in FIGS. 8-10, and/or FIGS. 15-17), and/or a segmenting model. In some embodiments, the phrase list may include a plurality of existing phrases. The plurality of existing phrases may include common phrases associated with the application scenario (e.g., phrases with a high usage frequency), specific phrases (e.g., proper nouns), newly generated phrases, or the like, or any combination thereof. In some embodiments, the segmenting model may be configured to segment a query. In some embodiments, the segmenting model may be trained based on a plurality of segmented queries. In some embodiments, the phrase list described above may be combined in the segmenting model.

In some embodiments, while segmenting the query, the query segmenting module 420 may select a segmenting mode. For example, the segmenting mode may include a coarse-grained segmenting mode, a fine-grain segmenting mode, a multi-granularity segmenting mode, etc.

The query rewriting module 430 may be configured to generate a rewritten query corresponding to the search query. As used herein, the rewritten query may represent the user intend more accurately. In some embodiments, the query rewriting module 430 may determine a rewritten phrase for each of the one or more phrases, and generate the rewritten query by combining the one or more rewritten phrases.

In some embodiments, the query rewriting module 430 may determine a rewritten phrase based on one or more candidate phrases, corresponding probabilities, and a predetermined threshold probability. For a phrase, the one or more corresponding candidate phrases may be associated with the phrase and a phrase adjacent to the phrase. In some embodiments, the one or more candidate phrases may include a synonym of the phrase, a same phrase of the phrase represented in another language, a phrase having similar semantic information of the phrase, a phrase with a predetermined usage frequency that is next to the adjacent phrase in the query, etc. The probability may refer to a probability that the candidate phrase represents a user intend. The greater the probability is, the more the candidate phrase may represent the user intend. In some embodiments, the predetermined threshold probability may be default settings of the query processing system 100, or may be adjustable under different situations.

In some embodiments, the query rewriting module 430 may generate the rewritten query based on iteration process. Assuming that the phrase sequence may include a first phrase, a second phrase, . . . , a (j−1)^{th} phrase, a j^{th} phrase, . . . , and an N^{th} phrase. In a first iteration, the processing engine 112 may determine one or more first candidate phrases for the first phrase and one or more first probabilities corresponding to the one or more first candidate phrases. The processing engine 112 may determine a first rewritten phrase with a probability greater than the predetermined threshold probability. Further, the processing engine 112 may determine one or more second candidate phrases for the second phrase and one or more second probabilities corresponding to the one or more second candidate phrases based on the first rewritten phrase. The processing engine 112 may determine a first rewritten phrase with a probability greater than the predetermined threshold probability. Similarly, the processing engine 112 may determine a j^{th} rewritten phrase based on a (j−1)^{th} rewritten phrase in a j^{th} iteration.

In some embodiments, the query rewriting module 430 may determine the rewritten query based on a query processing model (also referred to as “text processing model”). In some embodiments, the query processing model may perform the iteration process described above to determine the rewritten query.

The query searching module 440 may be configured to perform a search based on the one or more phrases to obtain a search result associated with the search query.

The model training module 450 may be configured to determine the query processing model. The model training module 450 may train a preliminary query processing model to determine the query processing model based on a plurality of historical search records. As used herein, each of the plurality of historical search records may include a historical query of a historical user (also referred to as “historical input text”) and a historical search result selected by the historical user (also referred to as “user selected result”) corresponding to the historical query.

The phrase list determination module 460 may be configured to determine the phrase list. In some embodiments, the phrase list determination module 460 may determine the phrase list based on a plurality of historical search records and a phrase dictionary. Each of the historical search records may at least include a historical query of a historical user. In some embodiments, the historical search record may also include a historical search result selected by the second historical user corresponding to the first historical query (also referred to as “selected historical search result”).

The modules in the processing engine 112 may be connected to or communicated with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the processing engine 112 may include a storage module (not shown) which may be used to store data generated by the above-mentioned modules, e.g., the query, the phrase list, the query processing model, etc. As another example, the model training module 450 and/or the phrase list determination module 460 may be unnecessary and the query processing model and/or the phrase list may be obtained from a storage device (e.g., the storage 140) disclosed elsewhere in the present disclosure or an external device in communication with the query processing system 100.

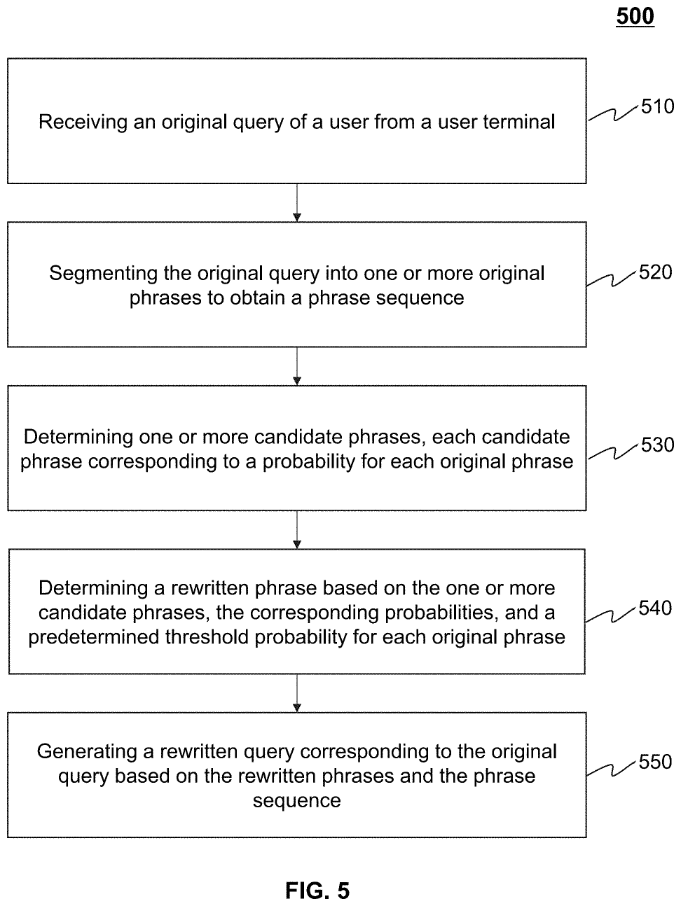

FIG. 5 is a flowchart illustrating an exemplary process for rewriting an original query according to some embodiments of the present disclosure. In some embodiments, process 500 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform process 500. The operations of the illustrated process presented below are intended to be illustrative. In some embodiments, process 500 may be accomplished with one or more additional operations not described and/or without one or more of the operations herein discussed. Additionally, the order in which the operations of the process as illustrated in FIG. 5 and described below is not intended to be limiting.

In 510, the processing engine 112 (e.g., the query obtaining module 410, the processing circuits of the processor 220) may receive an original query (also referred to as “input text”) of a user from the user terminal 130. In some embodiments, the user may input the original query via the user terminal 130. For example, the user may input the original query via an application installed on the user terminal 130. In some embodiments, the user may input the original query via typing input, hand gesturing input, voice input, picture input, etc. In some embodiments, the input may be done through a key board, a touch screen, a microphone, a hand-writing board, a scanner, a camera, or the like, or any combination thereof.

In some embodiments, the original query may refer to a term that the user intends to search, and the original query may be used for further search. In some embodiments, the original query may be incorrect to represent what the user intends to search. In some embodiments, the user may misspell the original query. In some embodiments, the user may use a wrong word, i.e., semantic information of the original query may be not identical with what the user intends to search. In some embodiments, the original query may be incomplete or ambiguous, and the original query may not represent what the user intends to search actually. Accordingly, before the original query is used for further search, the processing engine 112 may rewrite the query and generate a rewritten query. As used herein, the rewritten query may represent the user intend more accurately than the original query. In some embodiments, the processing engine 112 may rewrite the query based on process 500-700 and the descriptions thereof.

In 520, the processing engine 112 (e.g., the query segmenting module 420, the processing circuits of the processor 220) may segment the original query into one or more original phrases to obtain a phrase sequence. As used herein, the phrase sequence may include the one or more original phrases arranged in a position sequence according to the original query. For example, if the original query is ABC, and the one or more phrases include Phrase A, Phrase B, and Phrase C, the phrase sequence may be (Phrase A, phrase B, and Phrase C).

In some embodiments, the processing engine 112 may segment the original query based on a segmenting technique. For example, the segmenting technique may include an N-gram technique, a forward maximum matching technique, a reverse maximum matching technique, a bidirectional maximum matching technique, a minimum matching technique, an optimal matching technique, a hidden Markov model, a maximum entropy model, a conditional random field model, a neural network model, an association-backtracking technique, or the like, or any combination thereof.

In some embodiments, the processing engine 112 may segment the original query based on the segmenting technique and a phrase list (e.g., a phrase list illustrated in FIGS. 8-10, and/or FIGS. 15-17). In some embodiments, the phrase list may include a plurality of existing phrases associated with a specific application scenario. In some embodiments, the plurality of existing phrases may include common phrases associated with the application scenario (e.g., phrases with a high usage frequency), specific phrases (e.g., proper nouns), newly generated phrases, or the like, or any combination thereof. As used herein, the proper noun may refer to a name of a person, a name of specific place, a name of a specific organization, etc. The newly generated phrases may refer to a new phrase used in the application scenario. Merely by way of example, the specific application scenario may include transportation (e.g., map navigation, goods delivery, meal delivery), shopping (e.g., online shopping), catering (e.g., meal ordering), health care, travelling, etc. Taking the transportation as an example, the phrase list may include phrases associated with Points of Interest (POI), and the phrase list may be also referred to as a POI phrase list.

In some embodiments, the phrase list may include one or more sub phrase lists, and each of the one or more sub lists may include a plurality of existing phrases associated with the specific application scenario for a specific region. For example, the region may include a city, a town, a county, etc. In some embodiments, the phrase list may include one or more sub phrase lists, and each of the one or more sub lists may include a plurality existing phrases associated with a specific application scenario.

In some embodiment, the processing engine 112 may segment the original query with a segmenting model. The segmenting model may be configured to segment a query. In some embodiments, the segmenting model may be trained based on a plurality of segmented queries. In some embodiments, the phrase list described above may be combined in the segmenting model, and the processing engine 112 may segment the original query based on the combined segmenting model.

In some embodiments, while segmenting the original query, the processing engine 112 may select a segmenting mode. For example, the segmenting mode may include a coarse-grained segmenting mode, a fine-grain segmenting mode, a multi-granularity segmenting mode, etc. In some embodiments, a length of a segmenting unit may be different for the fine-grain segmenting mode, the coarse-grained segmenting mode. Specifically, a length of a segmenting unit corresponding to the fine-grain segmenting mode may be smaller than a length of a segmenting unit corresponding to the coarse-grained segmenting mode. In some embodiments, the multi-granularity segmenting mode may be a combination of the coarse-grained segmenting mode and the fine-grain segmenting mode. In some embodiments, the length of the segmenting unit for the segmenting mode may be predetermined based on practical demands. Taking Zhejiang University as an example, Zhejiang may be regarded as a segmenting unit, or Zhe, Jiang may be respectively regarded as a segmenting unit, or Zhejiang University may be regarded as a segmenting unit.

In 530, the processing engine 112 (e.g., the query rewriting module 430, the processing circuits of the processor 220) may determine one or more candidate phrases for each of the one or more original phrases. For an original phrase, the one or more corresponding candidate phrases may be associated with the original phrase and an original phrase adjacent to the original phrase. In some embodiments, the one or more candidate phrases may include a synonym of the original phrase, a same phrase of the original phrase represented in another language, a phrase having similar semantic information of the original phrase, a phrase with a predetermined usage frequency that is next to the adjacent original phrase in the original query, etc.

The processing engine 112 may also determine a probability for each candidate phrase. The probability may refer to a probability that the candidate phrase represents a user intend. The greater the probability is, the more the candidate phrase may represent the user intend.

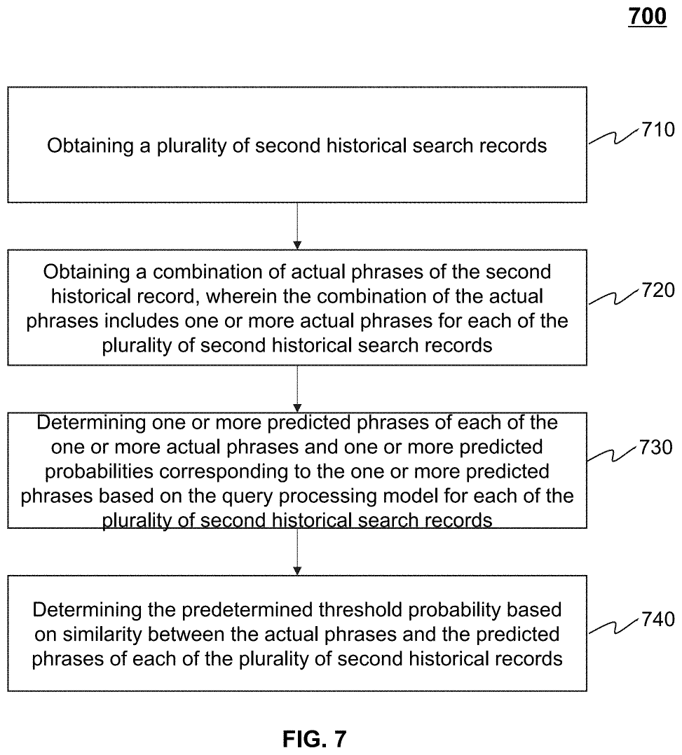

In 540, the processing engine 112 (e.g., the query rewriting module 430, the processing circuits of the processor 220) may determine a rewritten phrase based on the one or more candidate phrases, the corresponding probabilities, and a predetermined threshold probability. In some embodiments, the predetermined threshold probability may be default settings of the query processing system 100, or may be adjustable under different situations. More detailed descriptions of the predetermined threshold probability can be found elsewhere in the present disclosure, e.g., FIG. 7 and the descriptions thereof.

In some embodiments, the processing engine 112 may determine a rewritten phrase for each of the one or more original phrases. In some embodiments, the processing engine 112 may determine the one or more rewritten phrases based on the position sequence of each of the one or more original phrases. The processing engine 112 may initiate an iteration process for determine the rewritten phrase for each of the one or more original phrases. Assuming that the phrase sequence may include a first original phrase, a second original phrase, . . . , a (j−1)^{th} original phrase, a j^{th} original phrase, . . . , and an N^{th} original phrase. In a first iteration, the processing engine 112 may determine one or more first candidate phrases for the first original phrase and one or more first probabilities corresponding to the one or more first candidate phrases. The processing engine 112 may determine a first rewritten phrase with a probability greater than the predetermined threshold probability. Further, the processing engine 112 may determine one or more second candidate phrases for the second original phrase and one or more second probabilities corresponding to the one or more second candidate phrases based on the first rewritten phrase. The processing engine 112 may determine a first rewritten phrase with a probability greater than the predetermined threshold probability. Similarly, the processing engine 112 may determine a j^{th} rewritten phrase based on a (j−1)^{th} rewritten phrase in a j^{th} iteration.

In 550, the processing engine 112 (e.g., the query rewriting module 430, the processing circuits of the processor 220) may generate a rewritten query corresponding to the original query based on the rewritten phrases and the phrase sequence. Compared to the original query, the rewritten query may represent the user intend more accurately.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. In some embodiments, operation 550 may omit, and the one or more rewritten phrases may be used for further search. In some embodiments, after the user inputs the original query, the processing engine 112 may determine whether the original query needs to rewrite. In response to a determination that the original query needs to rewrite (e.g., the original query is incorrect), the processing engine 112 may perform process 500 to rewrite the query. In response to a determination that the original query does not need to rewrite, the processing engine 112 may use the one or more original phrases determined in 520 for further search.

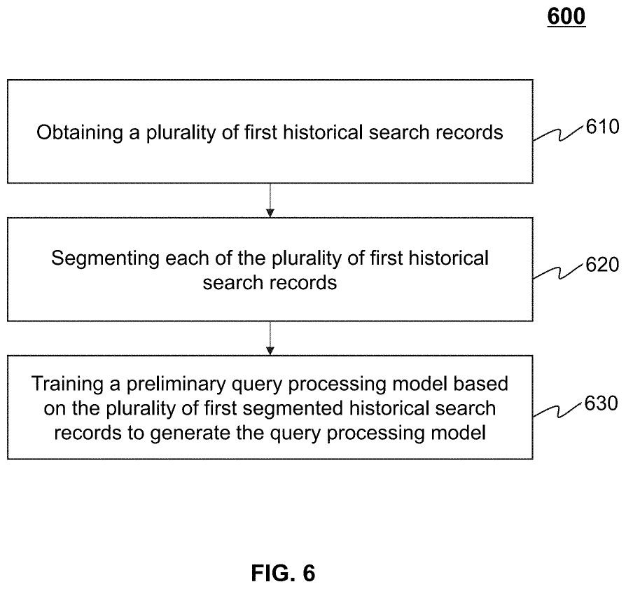

FIG. 6 is a flowchart illustrating an exemplary process for determining a query processing model according to some embodiments of the present disclosure. In some embodiments, process 600 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform process 600. The operations of the illustrated process presented below are intended to be illustrative. In some embodiments, process 600 may be accomplished with one or more additional operations not described and/or without one or more of the operations herein discussed. Additionally, the order in which the operations of the process as illustrated in FIG. 6 and described below is not intended to be limiting.

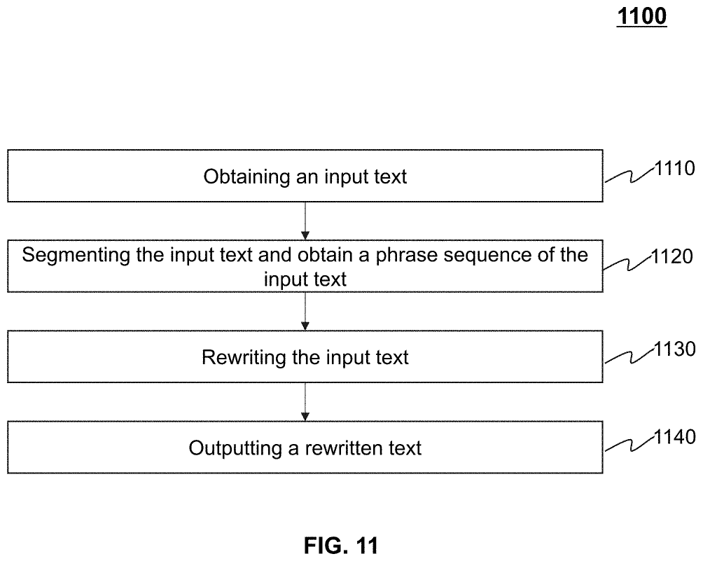

In some embodiments, the processing engine 112 may use a query processing model (also referred to as “text processing model” described in FIGS. 11-14) to determine the one or more candidate phrases, the one or more corresponding probabilities. The query processing model be configured to determine a rewritten phrase corresponding to an original phrase. The rewritten phrase may represent the user intend more accurately. In some embodiments, the query processing model may be predetermined by the query processing system 100 (e.g., the processing engine 112) or a third party (e.g., an external database). The query processing engine 112 may predetermine the query processing model based on the process 600.

In 610, the processing engine 112 (e.g., the model training module 450, the processing circuits of the processor 220) may obtain a plurality of first historical search records. As used herein, each of the plurality of first historical search records may include a first historical query of a first historical user (also referred to as “historical input text”) and a first historical search result selected by the first historical user (also referred to as “first user selected result”) corresponding to the first historical query.

In some embodiments, the processing engine 112 may obtain the plurality of first historical search records within a predetermined time period (e.g., the last month, the last three months, the last year). In some embodiments, the processing engine 112 may obtain the plurality of first historical search records from a storage device (e.g., the storage 140) disclosed elsewhere in the present disclosure, an external database, etc.

In 620, the processing engine 112 (e.g., the model training module 450, the processing circuits of the processor 220) may segment each of the plurality of first historical search records. For each first historical search record, the processing engine 112 may segment the first historical query and the first historical search result selected by the first historical user corresponding to the first historical query, respectively. Similar to operation 520, as shown in FIG. 5, the processing engine 112 may segment each of the plurality of first historical search records based on the segmenting technique and/or the segmenting model.

In 630, the processing engine 112 (e.g., the model training module 450, the processing circuits of the processor 220) may train a preliminary query processing model based on the plurality of segmented first historical search records to generate the query processing model. In some embodiments, the preliminary query processing model may include a sequence to sequence learning (Seq2Seq) model including attention mechanism. For example, the preliminary query processing model may include a Convolutional Neural Network (CNN) model, a recurrent neural network (RNN) model (e.g., a Gated Recurrent Unit (GRU), a Long-Short Term Memory (LSTM), a Bidirectional Recurrent Neural Network (BiRNN)), or the like, or any combination thereof.

For each first historical search record, the processing engine 112 may determine similarities between one or more rewritten phrases of the segmented first historical query and one or more phrase the segmented first user selected result. In some embodiments, the processing engine 112 may determine a similarity between each pair of phrases that are in the same position sequence of the segmented first historical query and the segmented first user selected result. In response to a determination that similarities of the plurality of first historical search records satisfy a predetermined condition, the processing engine 112 may designate the preliminary query processing model as the query processing model. In some embodiments, the processing engine 112 may determine a loss function of the preliminary query processing model and determine a value of the loss function based on the similarities. Further, the processing engine 112 may determine whether the value of the loss function is less than a threshold. In response to a determination that the value of the loss function is less than the threshold, the similarities of the plurality of first historical search records may satisfy the predetermined condition. The threshold may be default settings of the proper noun identification system 100, or may be adjustable under different situations.

In response to a determination that the similarities do not satisfy the predetermined condition, the processing engine 112 may update the preliminary query processing model. For example, the processing engine 112 may update one or more preliminary parameters (e.g., a weight matrix, a bias vector) of the preliminary query processing model to produce an updated query processing model.

Further, the processing engine 112 may determine whether updated similarities under the updated query processing model satisfy the predetermined condition. In response to a determination that the updated similarities satisfy the predetermined condition, the processing engine 112 may designate the updated query processing model as the query processing model. On the other hand, in response to a determination that the updated similarities still do not satisfy the predetermined condition, the processing engine 112 may still update the updated query processing model until the plurality of updated similarities satisfy the predetermined condition.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. In some embodiments, the query processing model may be updated based on a plurality of newly obtained first historical search records.

FIG. 7 is a flowchart illustrating an exemplary process for determining a predetermined threshold probability according to some embodiments of the present disclosure. In some embodiments, process 700 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform process 700. The operations of the illustrated process presented below are intended to be illustrative. In some embodiments, process 700 may be accomplished with one or more additional operations not described and/or without one or more of the operations herein discussed. Additionally, the order in which the operations of the process as illustrated in FIG. 7 and described below is not intended to be limiting.

In some embodiments, the query processing system 100 (e.g., the processing engine 112) or a third party may use the query processing model to determine the predetermined threshold probability. Merely by way of example, the processing engine 112 may determine the predetermined threshold based on the query processing model according to process 700.

In 710, the processing engine 112 (e.g., the query rewriting module 430, the processing circuits of the processor 220) may obtain a plurality of second historical search records (also referred to as “validation dataset”). Similar to the plurality of first historical search records, each of the plurality of second historical search records may include a second historical query of a second historical user and a second historical search result selected by the second historical user corresponding to the second historical query (also referred to as “selected second historical search result”). As used herein, the second historical queries may be incorrect queries. In some embodiments, the plurality of second historical search record may be different from the second historical search records.

In 720, the processing engine 112 (e.g., the query rewriting module 430, the processing circuits of the processor 220) may obtain a combination of actual phrases (also referred to as “actual phrase sequence”) of the second historical record for each of the plurality of second historical search records. In some embodiments, the processing engine 112 may segment each of the plurality of second historical search records. The processing engine 112 may segment the second historical query and the selected second historical search result, respectively. Each phrase of a phrase sequence of the segmented selected second historical search result may correspond to a phrase of a phrase sequence with the same position sequence of the segmented second historical query. Since the second historical query may be incorrect, and the selected second historical search result may represent the user intend more optimally, the processing engine 112 may designate a phrase sequence of the selected second historical search result as the combination of the actual phrases of the second historical record.

As described in connection with FIGS. 5-6, the processing engine 112 may segment the second historical search records based on the segmenting technique, the phrase list, and/or the segmenting model. In some embodiments, the processing engine 112 may segment the second historical search records based on the same process for segmenting the first historical search records and/or the original query. In some embodiments, a segmenting mode of the second historical search records may be the same as the segmenting mode of the first historical search records and/or the original query.

In 730, the processing engine 112 (e.g., the query rewriting module 430, the processing circuits of the processor 220) may determine one or more predicted phrases corresponding to the one or more actual phrases and one or more predicted probabilities corresponding to the one or more predicted phrases based on the query processing model. Specifically, the processing engine 112 may determine the one or more predicted phrases based on the phrase sequence of the segmented second historical query using the query processing model. The predicted probability may refer to a probability that a predicted phrase represents a user intend. The greater the probability is, the more the candidate phrase may represent the user intend.

In 740, the processing engine 112 (e.g., the query rewriting module 430, the processing circuits of the processor 220) may determine the predetermined threshold probability based on similarities between the actual phrases and the corresponding predicted phrases of each of the plurality of second historical records. In some embodiments, for an actual phrase, the processing engine 112 may determine one or more similarities between the actual phrase and each of one or more predicted phrases corresponding to the actual phrase. Further, the processing engine 112 may determine a predicted phrase with a largest similarity among the one or more similarities. The processing engine 112 may determine the predetermined threshold probability based on a predicted probability corresponding to the predicted phrase with a largest similarity for each actual phrase. In some embodiments, the processing engine 112 may determine a probability range based on the similarities. The processing engine 112 may set the predetermined threshold probability based on the probability range. In some embodiments, the predetermined threshold probability may be a value in the probability range. In some embodiments, the processing engine 112 may also determine a relatively narrow probability range based on the probability range. The relatively narrow probability range may be a probability range that most of the probabilities may be within. The predetermined threshold probability may be a value in the relatively narrow probability range. In some embodiments, the processing engine 112 may obtain a plurality of sets of the second historical search records. For each set of the second historical search records, the processing engine 112 may determine a probability and/or a probability range. The processing engine 112 may determine the predetermined threshold probability based on the probabilities or the probability ranges.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

FIG. 8 is a flowchart illustrating an exemplary process for performing a search of a query based on a phrase list according to some embodiments of the present disclosure. In some embodiments, process 800 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform process 800. The operations of the illustrated process presented below are intended to be illustrative. In some embodiments, process 800 may be accomplished with one or more additional operations not described and/or without one or more of the operations herein discussed. Additionally, the order in which the operations of the process as illustrated in FIG. 8 and described below is not intended to be limiting.

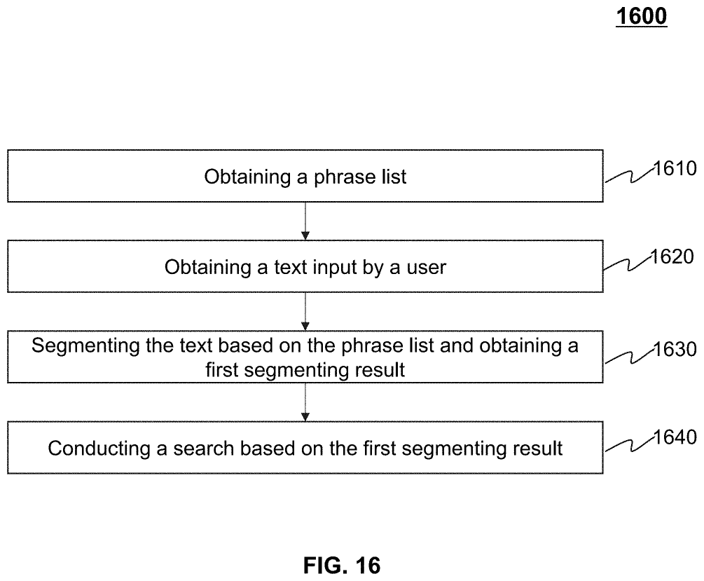

In 810, the processing engine 112 (e.g., the query obtaining module 410, the processing circuits of the processor 220) may obtain a query (also referred to as “text” or “input text” described in FIGS. 16-18) of a user from the user terminal 130. Similar to the original query illustrated in 510, the user may input the query via the user terminal 130. For example, the user may input the query via an application installed on the user terminal 130. In some embodiments, the user may input the query via typing input, hand gesturing input, voice input, picture input, video input, eye movement input, etc. In some embodiments, the input may be done through a key board, a touch, a mouse, a screen, a microphone, a hand-writing board, a scanner, a camera, or the like, or any combination thereof.

In some embodiments, if the user inputs the query via voice input, picture input, video input, etc., the processing engine 112 may obtain the query based on an image recognition technique and/or a voice recognition technique. For example, the user may input an image obtained from a camera installed on the user terminal 130. The processing engine 112 may identify the image and obtain the query based on the image recognition technique. As another example, the user may input a voice segment via a microphone installed on the user terminal 130. The processing engine 112 may identify the voice segment and obtain the query based on the voice recognition technique.

As used herein, the query may refer to a term that the user intends to search, and the query may be used for further search. In some embodiments, the query may be associated with a specific application scenario, e.g., transportation (e.g., map navigation, products delivery, meal delivery), shopping (e.g., online shopping), catering (e.g., meal ordering,), health care, travelling, etc. etc.

In 820, the processing engine 112 (e.g., the query segmenting module 420, the processing circuits of the processor 220) may segment the query into one or more phrases (also referred to as “first segmenting result” described in FIGS. 16-18) based on a phrase list. In some embodiments, the phrase list may include a plurality of existing phrases associated with a specific application scenario. In some embodiments, the plurality of existing phrases may include common phrases associated with the application scenario (e.g., phrases with a high usage frequency), specific phrases (e.g., proper nouns), newly generated phrases, or the like, or any combination thereof. As used herein, the proper noun may refer to a name of a person, a name of specific place, a name of a specific organization, a website, a fraction, a phone number, an E-mail, a date, a time point, etc. The newly generated phrase may refer to a new phrase used in the application scenario. Merely by way of example, the specific application scenario may include transportation (e.g., map navigation, products delivery, meal delivery), shopping (e.g., online shopping), catering (e.g., meal ordering,), health care, travelling, etc. Taking the transportation as an example, the phrase list may include phrases associated with Points of Interest (POIs), and the phrase list may be also referred to as a POI phrase list.

In some embodiments, the phrase list may include one or more sub phrase lists, and each of the one or more sub lists may include a plurality of existing phrases associated with the specific application scenarios for a specific region. For example, the region may include a city, a town, a county, etc. In some embodiments, the phrase list may include one or more sub phrase lists, and each of the one or more sub lists may include a plurality existing phrases associated with a specific application scenario.

In some embodiments, as described in FIG. 5, the processing engine 112 may segment the query based on the phrase list and a segmenting technique. For example, the segmenting technique may include an N-gram technique, a forward maximum matching technique, a reverse maximum matching technique, a bidirectional maximum matching technique, a minimum matching technique, an optimal matching technique, a hidden Markov model, a maximum entropy model, a conditional random field model, a neural network model, an association-backtracking technique, or the like, or any combination thereof.

In some embodiments, the processing may segment the query based on the phrase list and a segmenting model. The segmenting model may be configured to segment a query. In some embodiments, the segmenting model may be trained based on a plurality of segmented queries. In some embodiments, the phrase list described above may be combined in the segmenting model, and the processing engine 112 may segment the query based on the combined segmenting model.

In 830, the processing engine 112 (e.g., the query searching module 440, the processing circuits of the processor 220) may perform a search based on the one or more phrases to obtain a search result associated with the query.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. In some embodiments, in 820, the processing engine 112 may determine whether the query needs to rewrite. In response to a determination that the query needs to rewrite (e.g., the query is incorrect), the processing engine 112 may also rewrite the one or more phrases, e.g., based on the query processing model described in the present disclosure, and generate one or more rewritten phrases corresponding to the one or more phrases in 820. The one or more rewritten phrases may be used for further search.

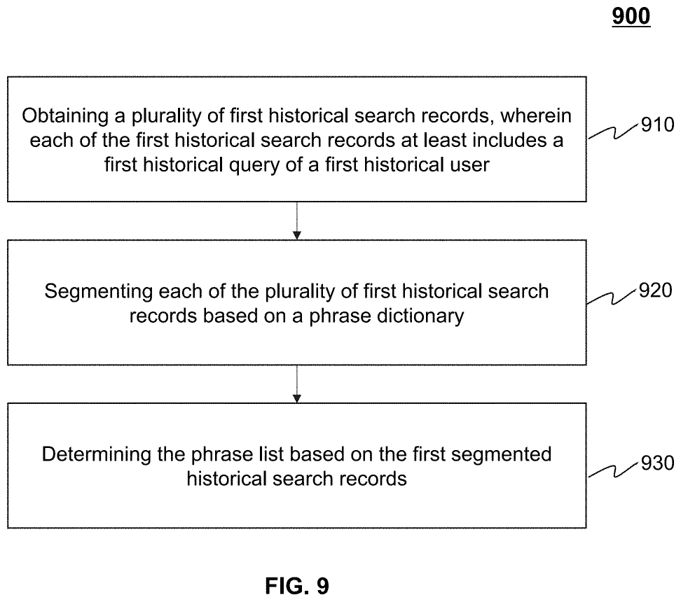

FIG. 9 is a flowchart illustrating an exemplary process for generating a phrase list according to some embodiments of the present disclosure. In some embodiments, process 900 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform process 900. The operations of the illustrated process presented below are intended to be illustrative. In some embodiments, process 900 may be accomplished with one or more additional operations not described and/or without one or more of the operations herein discussed. Additionally, the order in which the operations of the process as illustrated in FIG. 9 and described below is not intended to be limiting.

In 910, the processing engine 112 (e.g., the phrase list determination module 460, the processing circuits of the processor 220) may obtain a plurality of first historical search records. Each of the first historical search records may at least include a first historical query of a first historical user. In some embodiments, the first historical search record may also include a first historical search result selected by the second historical user corresponding to the first historical query (also referred to as “selected first historical search result”).

In some embodiments, the processing engine 112 may expand the plurality of first historical search records based on a data smoothing model and a corpus expansion model. The data smoothing model may include a Laplace algorithm, a Good-Turing algorithm, an absolute discount algorithm, a linear discount algorithm, a Witten-Bell algorithm, or the like, or any combination thereof. The corpus expansion model may include synonym expansion and/or phrase class expansion.

In 920, the processing engine 112 (e.g., the phrase list determination module 460, the processing circuits of the processor 220) may segment each of the plurality of (expanded) first historical search records based on a phrase dictionary. In some embodiments, the phrase dictionary may include a plenty of original phrases used in various applications, e.g., a corpus database. In some embodiments, the phrase dictionary may include a plurality of original phrases associated with a specific application scenario, and the phrase dictionary may be used to determine a phrase list associated with the specific application scenario.

In some embodiments, the processing engine 112 may segment each of the plurality of (expanded) first historical search records based on the phrase dictionary and a segmenting technique. For example, the segmenting technique may include an N-gram technique, a forward maximum matching technique, a reverse maximum matching technique, a bidirectional maximum matching technique, a minimum matching technique, an optimal matching technique, a hidden Markov model, a maximum entropy model, a conditional random field model, a neural network model, an association-backtracking technique, or the like, or any combination thereof.

In some embodiments, the processing engine 112 may select a segmenting model for the segmenting. For example, the segmenting mode may include a multi-granularity segmenting mode, a coarse-grained segmenting mode, a fine-grain segmenting mode, etc. In some embodiments, the processing engine 112 may select the segmenting mode based on practical demands.

In 930, the processing engine 112 (e.g., the phrase list determination module 460, the processing circuits of the processor 220) may determine the phrase list based on the segmented first historical search records. In some embodiments, the processing engine 112 may determine the phrase list based on an iteration process. In each iteration, the processing engine 112 may segment one first historical search record of the plurality of first historical search records based on the phrase dictionary. Further, the processing engine 112 may determine whether the segmented first historical search record satisfies a predetermined condition (also referred to as “predetermined rule”. The predetermined condition may include a usage frequency of a phrase greater than a first threshold, a relevance degree of a phrase associated with a specific application scenario greater than a second threshold, a phrase simultaneously appears in a first historical query and a selected first historical search result corresponding to the first historical query, or the like, or any combination thereof.

In response to a determination that the segmented first historical search record satisfies the predetermined condition, the processing engine 112 may add the segmented first historical search record to the phrase dictionary to generate a new phrase dictionary. Further, the processing engine 112 may segment another first historical search record of the plurality of first historical search records based on the new phrase dictionary.

In response to a determination that the segmented first historical search record does not satisfy the predetermined condition, the processing engine 112 may further segment another first historical search record of the plurality of first historical search records based on the phrase dictionary.

In some embodiments, the iteration process may terminate unit all of the plurality of (expanded) first historical search records are processed based on the iteration described above. The processing engine 112 may obtain the phrase list based on the phrase dictionary determined in the last iteration. In some embodiments, the phrase dictionary determined in the last iteration may be designated as the phrase list.

In some embodiments, the processing engine 112 may update the phrase list based on a plurality of newly obtained historical search records based on process 900.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

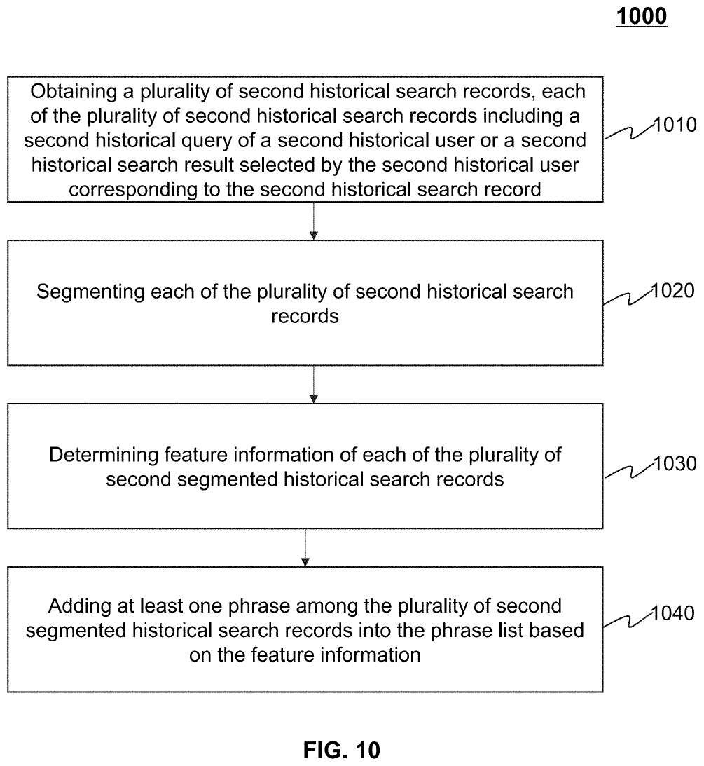

FIG. 10 is a flowchart illustrating an exemplary process for supplementing a phrase list according to some embodiments of the present disclosure. In some embodiments, process 1000 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform process 1000. The operations of the illustrated process presented below are intended to be illustrative. In some embodiments, process 1000 may be accomplished with one or more additional operations not described and/or without one or more of the operations herein discussed. Additionally, the order in which the operations of the process as illustrated in FIG. 10 and described below is not intended to be limiting.

In 1010, the processing engine 112 (e.g., the phrase list determination module 460, the processing circuits of the processor 220) may obtain a plurality of second historical search records. Similar to the plurality of first historical search records described in FIG. 9, each of the plurality of second historical search records may include a second historical query of a second historical user or a second historical search result selected by the second historical user (also referred to as “selected second historical search result”) corresponding to the second historical search record. In some embodiments, the plurality of second historical search records may be different from the plurality of first historical search records.

In 1020, the processing engine 112 (e.g., the phrase list determination module 460, the processing circuits of the processor 220) may segment each of the plurality of second historical search records. As described in connection with FIGS. 5-9, the processing engine 112 may segment the second historical search record based on the segmenting technique, and/or the segmenting model. In some embodiments, the processing engine 112 may segment each of the second historical query and the selected second historical search result into one or more second phrases respectively.

In 1030, the processing engine 112 (e.g., the phrase list determination module 460, the processing circuits of the processor 220) may determine feature information of each of the plurality of segmented second historical search records. Specifically, the processing engine 112 may determine the feature information of the one or more phrases. For example, the feature information may include a cohesive parameter between two phrases of the one or more phrases, a degree of freedom of a phrase, and a habit of the user, or the like, or any combination thereof. As used herein, the cohesive parameter may refer to a correlation or a cohesion between at least two phrases, i.e., a probability that the at least two phrases may constitute of a single phrase. The degree of freedom may indicate a probability that at least two phrases appear independently, i.e., a probability that the at least two phrases may not constitute the single phrase.

In 1040, the processing engine 112 (e.g., the phrase list determination module 460, the processing circuits of the processor 220) may add at least one phrase among the plurality of segmented second historical search records into the phrase list based on the feature information. In some embodiments, the processing engine 112 may add the at least one phrase based on a ratio associated with the cohesive parameter and the degree of freedom. As used herein, the ratio may be a ratio of a total count of the second historical queries including the at least two phrases and the selected second historical search results including the at least two phrases to a total count of the second historical queries and the selected second historical search results. The greater the ratio is, the more cohesive the at least two phrases may be, and the less free the at least two phrases may be. In some embodiments, if the ratio is greater than a first predetermined threshold, the at least two phrases may be cohesive (i.e., constituting a single phrase). In some embodiments, if the ratio is smaller than a second predetermined threshold, the two phrases may be not cohesive enough to be used as the singe phrase.

In some embodiments, in response to a determination that the ratio is greater than the first predetermined threshold (e.g., 0.6), the processing engine 112 may supplement the single phrase into the phrase list. In some embodiments, in response to a determination that the ratio is smaller than the second predetermined threshold (e.g., 0.4), the processing engine 112 may not supplement the single phrase into the phrase list.

In some embodiments, the processing engine 112 may further supplement the phrase list based on a plurality of newly obtained historical search records based on process 1000.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

FIG. 11 is a flowchart illustrating an exemplary process for processing a text according to some embodiments of the present disclosure. In some embodiments, process 1100 may be implemented as a set of instructions (e.g., an application) stored in the storage ROM 230 or RAM 240. The processor 220, and/or the modules in FIG. 4, may execute the set of instructions, and when executing the instructions, the processor 220 and/or the modules may be configured to perform process 1100. The operations of the illustrated process presented below are intended to be illustrative. In some embodiments, process 1100 may be accomplished with one or more additional operations not described and/or without one or more of the operations herein discussed. Additionally, the order in which the operations of the process as illustrated in FIG. 11 and described below is not intended to be limiting. For example, process 1100 described below may be implemented on the processing engine 112.

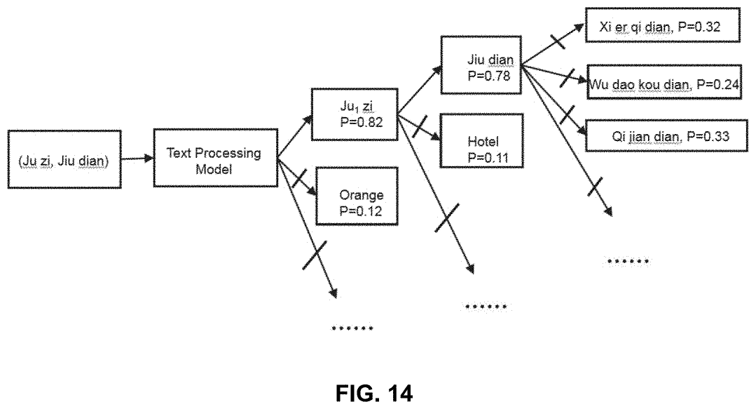

In 1110, the processing engine 112 may receive a request for an input text of a user via the user terminal 130. The input text may be correct, complete, incomplete, ambiguous and/or incorrect. As shown in FIG. 14, the user may input a text “Ju zi jiu dian” in Chinese, and the user inputs “Ju” incorrectly. The input text may be similar to the original query described in FIGS. 4-7, and not repeated in detail here.

In 1120, the processing engine 112 may segment the input text using a segmenting tool (also referred to as “segmenting technique” described in FIGS. 5-12). More detailed descriptions of the segmenting tool can be found in FIGS. 5-12, and the descriptions thereof. The processing engine 112 may obtain a phrase sequence of the input text. In some embodiments, the processing engine 112 may segment the input text based on a segmenting mode, e.g., a multi-granularity segmenting mode, a coarse-grained segmenting mode, a fine-grain segmenting mode, etc. More detailed descriptions of the segmenting mode can be found elsewhere in the present disclosure, e.g., FIGS. 5-10 and the descriptions thereof. As shown in FIG. 14, the input text is “Ju zi Jiu dian”, and the processing engine 112 segments “Ju zi jiu dian” and obtains (Ju zi, Jiu dian) as a phrase sequence of “Ju zi jiu dian”.

In 1130, the processing engine 112 may rewrite the query using the phrase sequence of the segmented input text. In some embodiments, the processing engine 112 may rewrite the input text based on a text processing model (also referred to as “query processing model” described in FIGS. 5-8). Taking (Ju zi, Jiu dian) shown in FIG. 14 as an example, the processing engine 112 may input (Ju zi, Jiu dian) into the text processing model and rewrite (Ju zi, Jiu dian).

In some embodiments, the processing engine 112 may rewrite the segmented input text according to a position sequence 1, 2, . . . , j, j+1, N in the phrase sequence. As used herein, j may be any integer of 1−N, and N may be a total number of original phrases in the phrase sequence. Taking (Ju zi, Jiu dian) shown in FIG. 14 as an example, the processing engine 112 may rewrite “Ju zi” and “Jiu dian” in sequence using the text processing model.

In some embodiments, when rewriting an original phrase in (j−1)^{th} position, the text processing model may obtain one or more candidate phrases and one or more probabilities of the one or more candidate phrases. The processing engine 112 may reserve a candidate phrase with a probability greater than a predetermined threshold among the one or more candidate phrases. Taking “Ju zi” shown in FIG. 14 as an example, one or more candidate phrases associated with “Ju zi” may include “Ju zi”, “Ju₁ zi”, orange, etc. As used herein, “Ju₁ zi” may represent another spelling of “Ju zi” in Chinese. The processing engine 112 may determine probabilities corresponding to “Ju₁ zi”, orange, and other phrases. A probability corresponding to “Ju₁ zi” may be 0.82. A probability corresponding to orange may be 0.12. A total of probabilities corresponding to “Ju₁ zi”, orange, and other phrases may be 1. If the predetermined threshold is 0.7, since the probability corresponding to “Juzi₁” is greater than the predetermined threshold, the processing engine 112 may reserve “Ju₁ zi” for the (j−1)^{th} position in the phrase sequence and delete other candidate phrases of the one or more candidate phrases.

In some embodiments, one or more candidate phrases determined for a j^{th} position in the position sequence may be associated with the reserved candidate phrase for the (j−1)^{th} position and the probability of the reserved candidate phrase. One or more probabilities of the one or more candidate phrases determined for the j^{th} position may be smaller than or equal to the probability of the reserved candidate phrase. As used herein, j may be any integer of 2−N. As shown in FIG. 14, the reserved phrase for “Ju zi” is “Ju₁ zi”, and the probability of “Ju₁ zi” is 0.82. The one or more candidate phrases determined for “Jiu dian” is “Jiu dian”, hotel and other phrases. A total of probabilities corresponding to “Jiu dian”, hotel and other phrases may be 1. A probability of “Jiu dian” is 0.78. A probability of hotel is 0.11. Thus, the probability of each of the one or more candidate phrases in the j^{th} position may be smaller than 0.82. If the predetermined threshold is 0.7, the processing engine 112 may reserve “Jiu dian” and delete other candidate phrases of the one or more candidate phrases.

In some embodiments, the text processing model may supplement the input text. Taking “Ju zi jiu dian” as an example, the text processing model may predict that the user searches ““Ju zi jiu dian” at a specific place. The processing engine 112 may supplement one or more candidate phrases representing a place for “Ju zi jiu dian”. As shown in FIG. 14, the one or more candidate phrases includes “Xi er qi dian” in Chinese, “Wu dao kou dian” in Chinese, “qi jian dian” in Chinese, and other phrases.

In some embodiments, if none of the one or more probabilities of the one or more candidate phrases in the j^{th} position is greater than the predetermined threshold, the text processing model may terminate the determination. As shown in FIG. 14, for the one or more supplemented candidate phrases after “Jiu dian”, a probability of “Xi er qi dian” may be 0.32. A total of probabilities corresponding to “Xi er qi dian”, and other phrases may be 1. A probability of “Wu dao kou dian” may be 0.24. A probability of “qi jian dian” may be 0.33. However, the probability of each of the one or more supplemented candidate phrases is smaller than the predetermined threshold (e.g., 0.7), the text processing model may terminate the determination and delete the one or more supplemented candidate phrases.

In some embodiments, the text processing model may rewrite the input text based on the phrase sequence. The text processing model may determine the rewritten text by combining the reserved candidate phrase for each position in the phrase sequence. As shown in FIG. 14, the rewritten text may be “Ju₁ zi jiu dian” by combing Ju₁ zi and “jiu dian”.

In 1140, the text processing model may output the rewritten text. As shown in FIG. 6B, the text processing model may output the rewritten text “Ju₁ zi jiu dian”. In some embodiments, the processing engine 112 may use the rewritten text for search. As shown in FIG. 14, the user inputs the incorrect text “Ju zi jiu dian”, and the text processing model may rewrite the incorrect text and output the rewritten text “Ju1 zi jiu dian”. The processing engine 112 may use “Ju1 zi jiu dian” for search.

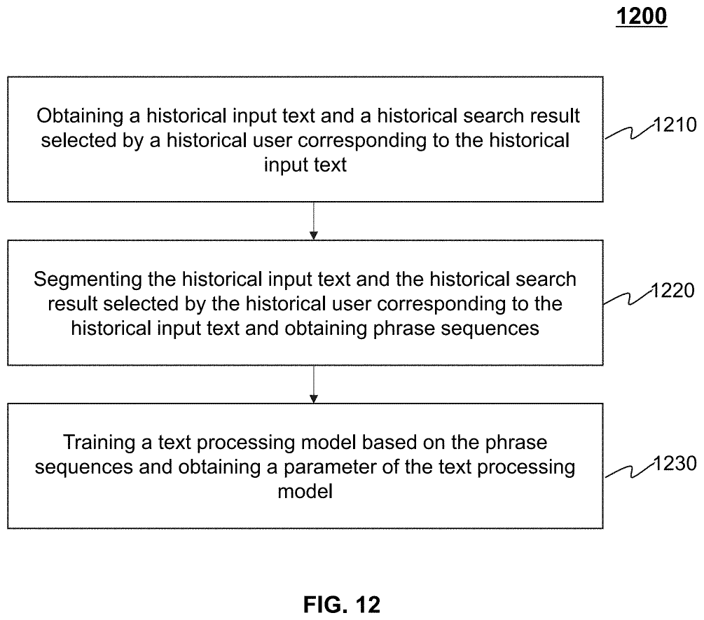

FIG. 12 is a flowchart illustrating an exemplary process for determining a text processing model according to some embodiments of the present disclosure. In some embodiments, process 1200 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform process 1200. The operations of the illustrated process presented below are intended to be illustrative. In some embodiments, process 1200 may be accomplished with one or more additional operations not described and/or without one or more of the operations herein discussed. Additionally, the order in which the operations of the process as illustrated in FIG. 12 and described below is not intended to be limiting.

The text processing model described in the present disclosure may include a sequence to sequence learning (Seq2Seq) model including attention mechanism. The text processing model may include an encoder, a decoder, and an attention module. The encoder may convert the input phrase sequence into a vector with a certain length. The decoder may convert the vector into an output phrase sequence. The Seq2Seq model may be effective to generate a short sentence or a short text, and less effective to generate a relatively long sentence or a relatively long text. The attention module may be used to solve the problem of loss of semantic information for the relatively long sentence. In some embodiments, the encoder and the decoder may include a Convolutional Neural Network (CNN) model, a recurrent neural network (RNN) model (e.g., a Gated Recurrent Unit (GRU), a Long-Short Term Memory (LSTM), a Bidirectional Recurrent Neural Network (BiRNN)), or the like, or any combination thereof. For example, the encoder of the text processing model may be the BiRNN, and the decoder may be the RNN.

In 1210, the processing engine 112 may obtain historical search records. Each of the historical search record may include a historical input text and a historical search result that the user was selected (e.g., an accurate name of a POI) corresponding to the historical input text. The historical input text may be correct, complete, incomplete, ambiguous and/or incorrect. For example, the accurate name of the POI may be “Ju₁ zi jiu dian xi er qi dian” in Chinese, and the historical input text may be an incomplete text “Ju₁ zi jiu dian”. As another example, the accurate name of the POI may be “Ju₁ zi jiu dian”, and the historical input text may be “Ju zi jiu dian”. In some embodiments, the processing engine 112 may designate the historical input texts and the historical selected search results as training samples.

In 1220, the processing engine 112 may segment the historical input texts and the historical selected search results based on a segmenting technique. The processing engine 112 may obtain a phrase sequence of each of the historical input text and each of the historical selected search result respectively. In some embodiments, the processing engine 112 may designate each of phrases in the phrase sequence as a minimum phrase unit for a text processing model. For example, if the historical input text is “Ju zi jiu dian”, the phrase sequence may be (Ju zi, jiu dian). If the historical selected search result corresponding to the historical input text is “Ju₁ zi jiu dian”, a segmenting sequence may be (“Ju₁ zi”, jiu dian). In some embodiment, the segmenting technique for the historical search records may be similar to the segmenting technique for the input text described in FIG. 11, and not repeated in detail here.

In 1230, the processing engine 112 may train the text processing model using the phrase sequences. The processing engine 112 may obtain at least one parameter (e.g., a weight matrix, a bias vector) of the text processing model and obtain the text processing model. In some embodiments, when the text processing model is used for rewriting, the text processing model may predict one or more candidate phrases and one or more weight values corresponding to the one or more candidate phrases for each position in the position sequence. In some embodiments, the processing engine 112 may normalize the one or more weight values and determine one or more probabilities corresponding to the one or more candidate phrases. For example, a process for determining the one or more probabilities corresponding to the one or more candidate phrases may be shown in FIG. 14. One or more candidate phrases for “Ju₁ zi” may include “Ju₁ zi”, orange, etc. The text processing model may normalize one or more weight values for the one or more candidate phrases for “Ju₁ zi” using a softmax function. A probability corresponding to “Ju₁ zi” may be 0.82. A probability corresponding to orange may be 0.12. A total of probabilities for each of the one or more candidate phrases may be 1.

In some embodiments, the processing engine 112 may determine the predetermined probability based on a validation set. In each position, the processing engine 112 may reserve no more than one candidate phrase based on the predetermined probability, which eliminates the ambiguity of the prediction. For example, the predetermined probability may be 0.7. In some embodiments, the validation set may include a set of texts collected manually. The set of texts may include a plurality of incorrect input texts and a plurality of correct input texts corresponding to the plurality of incorrect input texts, such as an incorrect text “Bu ding jiu dian” in Chinese and a correct text “Bu₁ ding jiu dian” in Chinese corresponding to “Bu ding jiu dian”. In some embodiments, the validate set may be different from the training samples.

In some embodiments, the processing engine 112 may input segmented incorrect texts into the text processing model for validation. The text processing model may output one or more predicted phrases for each phrase in the segmented incorrect text, and one or more predicted probabilities corresponding to the one or more predicted phrases. The processing engine 112 determine similarities between the one or more predicted phrases and a phrase in the segmented correct text at the same position. The processing engine 112 may reserve a predicted phrase with a highest similarity for each of the phrases in the segmented incorrect text and a predicted probability of the predicted phrase with the highest similarity. The processing engine 112 may determine a threshold range based on probabilities of the reserved phrases. Taking an incorrect text “Bu ding jiu dian” as an example, an output of the text processing model may be ((“Bu₁ ding”, “Bu ding”, pudding), (“jiu dian”, hotel, “Ivguan”)). A predicted probability of “Bu₁ ding” may be 0.8. A predicted probability of “Bu ding” may be 0.1. A predicted probability of “pudding” may be 0.1. A total of predicted probabilities of “Bu₁ ding”, “Bu ding” and pudding may be 1. A predicted probability of “jiu dian” may be 0.7. A predicted probability of “hotel” may be 0.2. A predicted probability of “Lv guan” may be 0.1. A total of predicted probabilities of “jiu dian”, hotel and “Ivguan” may be 1. The processing engine 112 may determine similarities between a correct phrase sequence (“Bu₁ ding”, “jiu dian”) and (“Bu₁ ding”, “Bu ding”, pudding), (“jiu dian”, hotel, “Ivguan”) based on the position sequence. The processing engine 112 may reserve “Bu₁ ding” and “jiu dian” respectively. In order to at most reserve a predicted phrase for each phrase in the incorrect text, the threshold range may be from 0.2 to 0.7. In some embodiments, the determination of the similarities may be performed manually. In some embodiments, the processing engine 112 may determine a plurality of threshold ranges based on a plurality of validation sets. The processing engine 112 may determine a narrow threshold range based on the plurality of threshold ranges. A target threshold range may be further set manually, which makes at most reserve a phrase for each position in the phrase sequence and improve the ability for rewriting the incorrect text.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

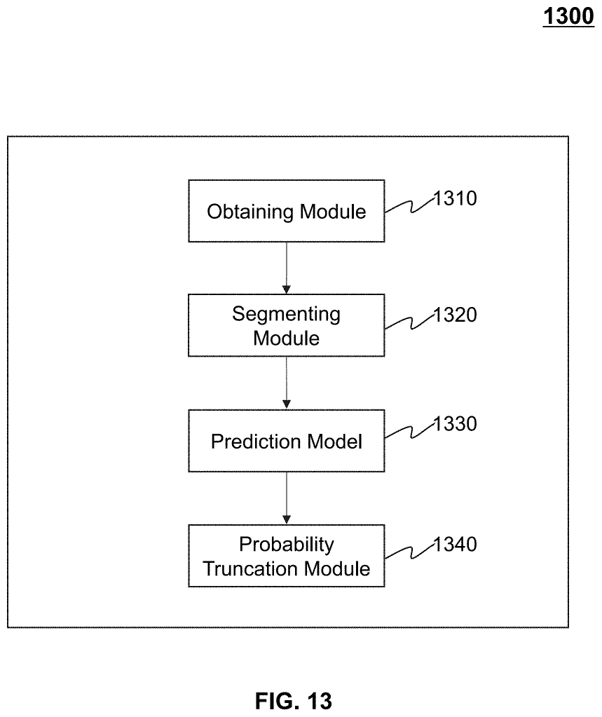

FIG. 14 is a flowchart illustrating an exemplary process for probability truncation according to some embodiments of the present disclosure. In some embodiments, process 1200 may be implemented as a set of instructions (e.g., an application) stored in the storage ROM 230 or RAM 240. The processor 220, the modules in FIG. 4 and/or modules in FIG. 13, may execute the set of instructions, and when executing the instructions, the processor 220 and/or the modules may be configured to perform process 1400. The operations of the illustrated process presented below are intended to be illustrative. In some embodiments, process 1100 may be accomplished with one or more additional operations not described and/or without one or more of the operations herein discussed. Additionally, the order in which the operations of the process as illustrated in FIG. 11 and described below is not intended to be limiting. FIG. 13 is a block diagram illustrating an exemplary query processing device according to some embodiments of the present disclosure. The query processing device 1300 may include an obtaining module 1310, a segmenting module 1320, a prediction module 1330, a probability truncation module 1340, and a combination module 1350. For example, process 1400 described below may be implemented on the text processing device 1300.

In 1410, the obtaining module 1310 may obtain a text of a user via the user terminal 130. The input text may be correct, complete, incomplete, ambiguous and/or incorrect. For example, a text that the user needs to search may be “Ju₁ zi jiu dian xi er qi dian”, however, the user inputs an ambiguous text “Ju₁ zi jiu dian”. As another example, a text that the user needs to search may be “Ju₁ zi jiu dian”, however, the user inputs an incorrect text “Ju zi jiu dian”.

In 1420, the segmenting module 1320 may segment the input text based on a segmenting technique and obtain a phrase sequence. For example, the segmenting technique may include an N-gram technique, a forward maximum matching technique, a reverse maximum matching technique, a bidirectional maximum matching technique, a minimum matching technique, an optimal matching technique, a hidden Markov model, a maximum entropy model, a conditional random field model, a neural network model, an association-backtracking technique, or the like, or any combination thereof. In some embodiments, while segmenting the input text, the processing engine 112 may select a segmenting mode. As described in connection with FIGS. 5-11, the segmenting mode may include a multi-granularity segmenting mode, a coarse-grained segmenting mode, a fine-grain segmenting mode, etc. In some embodiments, the processing engine 112 may segment the input text based on the multi-granularity segmenting mode and obtain the phrase sequence. For example, the input text of the user may be “Ju zi jiu dian”, and the phrase sequence may be (Ju zi, jiu dian).

In 1430, according to a position sequence 1, 2, . . . , j, j+1, N in the phrase sequence, the prediction module 1330 may predict and obtain one or more candidate phrases for each original phrase at each of the positions and one or more probabilities corresponding to the one or more candidate phrases. j may be any integral of 1−N, and N may be a total number of the original phrases in the input text. As shown in FIG. 14, the prediction module 1330 rewrite “Ju zi” and “Jiu dian” in sequence using a text processing model.

In some embodiments, when rewriting a phrase in (j−1)^{th} position, the text processing model may obtain one or more candidate phrases and one or more probabilities of the one or more candidate phrases. As shown in FIG. 14, when rewriting ““Ju zi”, one or more candidate phrases associated with “Ju zi” may include “Ju zi”, “Ju₁ zi”, orange, etc. As used herein, “Ju₁ zi” may represent another spelling of “Ju zi” in Chinese. A probability corresponding to “Ju₁ zi” may be 0.82. A probability corresponding to orange may be 0.12. A total of probabilities corresponding to “Ju₁ zi”, orange, and other phrases may be 1.

In some embodiments, one or more candidate phrases determined for a j^{th} position in the position sequence may be associated with the reserved candidate phrase for the (j−1)^{th} position and the probability of the reserved candidate phrase. One or more probabilities of the one or more candidate phrases determined for the j^{th} position may be smaller than or equal to the probability of the reserved candidate phrase. As used herein, j may be any integer of 2−N. As shown in FIG. 14, when rewriting “Jiu dian”, based on “Ju₁ zi” before “Jiu dian”, one or more candidate phrases determined for “Jiu dian” is “Jiu dian”, hotel and other phrases. A total of probabilities corresponding to “Jiu dian”, hotel and other phrases may be 1. A probability of “Jiu dian” is 0.78. A probability of hotel is 0.11. The probability of each of the one or more candidate phrases in the j^{th} position may be smaller than the probability of “Ju₁ zi” (0.82). Similarly, when predicting “Xi er qi dian”, based on the “Jiu dian” before “Xi er qi dian”, one or more candidate phrases determined for “Xi er qi dian” may be “Xi er qi dian”, “Wu dao kou dian”, “Qi jian dian” and other phrases. A total of probabilities corresponding to “Xi er qi dian”, “Wu dao kou dian”, “Qi jian dian” and other phrases may be 1. A probability of “Xi er qi dian” may be 0.32. A probability of “Wu dao kou dian” may be 0.24. A probability of “qi jian dian” may be 0.33. The probability of each of the one or more candidate phrases for “Xi er qi dian” may be smaller than the probability of “Jiu dian” (0.78).

In some embodiments, the prediction module 1330 may implement the functions by the text processing model.

In 1440, the probability truncation module 1340 may reserve a candidate phrase with a probability greater than a predetermined threshold for each position in the phrase sequence. As shown in FIG. 14, a total of probabilities corresponding to “Ju₁ zi”, orange, and other phrases may be 1. If the predetermined threshold is 0.7, since the probability corresponding to “Ju₁ zi” is greater than the predetermined threshold, the processing engine 112 may reserve “Ju₁ zi” for the (j−1)^{th} position in the phrase sequence and delete other candidate phrases of the one or more candidate phrases. Similarly, a total of probabilities corresponding to “Jiu dian”, hotel and other phrases may be 1. If the predetermined threshold is 0.7, since the probability of “Jiu dian” is greater than the predetermined threshold. The processing engine 112 may reserve “Jiu dian” and delete other candidate phrases of the one or more candidate phrases.

In some embodiment, if none of the one or more probabilities of the one or more candidate phrases in the j^{th} position is greater than the predetermined threshold, the text processing model may terminate the determination. As shown in FIG. 14, when predicting “Xi er qi dian”, one or more candidate phrases determined for “Xi er qi dian” may be “Xi er qi dian”, “Wu dao kou dian”, “Qi jian dian” and other phrases. A total of probabilities corresponding to “Xi er qi dian”, and other phrases may be 1. A probability of “Xi er qi dian” may be 0.32. A probability of “Wu dao kou dian” may be 0.24. A probability of “qi jian dian” may be 0.33. However, the probability of each of the one or more candidate phrases is smaller than the predetermined threshold (e.g., 0.7), the text processing model may terminate the determination and delete the one or more candidate phrases.

In some embodiments, the query processing device 1300 may also include the combination module 1350. The combination module 1350 may combine the reserved candidate phrases based on the phrase sequence and obtain a rewritten input text. In some embodiments, the query processing device 1300 may also include a retrieval module. The retrieval module may be used to conduct a search using the rewritten input text. For example, the user may input an incorrect text “Ju zi jiu dian”, the text processing model may rewrite the incorrect text “Ju zi jiu dian” as “Ju₁ zi jiu dian”. The retrieval module may use “Ju₁ zi jiu dian” to conduct a search.

FIG. 15 is a block diagram illustrating an exemplary semantic retrieval device according to some embodiments of the present disclosure. A portion or all of function of modules in the device 1500 may be implemented on the user terminal 130.

The device 1500 may include a first obtaining module 1510, a first segmenting module 1520, and a searching module 1530. Connections between each of the two modules may be wired and/or wireless. Each of the modules may be remote and/or local. A corresponding relationship between each of the two modules may be one-to-one or one-to-many.

The first obtaining module 1510 may obtain data. In some embodiments, the first obtaining module 1510 may obtain the data from the user terminal 130. In some embodiments, the processing engine 112 may obtain the data from the storage 130, or the network 120. The data obtained by the first obtaining module 1510 may include a phrase list (e.g., a POI phrase list) and a text input by a user. In some embodiments, the data obtained by the first obtaining module 1510 may be transmitted to the first segmenting module 1520 and/or the searching module 1530. For example, the first obtaining module 1510 may obtain the POI phrase list, and the first segmenting module 1520 may segment the text based on the POI phrase list and obtain a first segmenting result.

The first segmenting module 1520 may obtain the first segmenting result. In some embodiments, the first segmenting module 1520 may segment the text and obtain the first segmenting result. In some embodiments, the text may be input by the user. The first segmenting module 1520 may segment the text based on a Hidden Markov Model, a Probabilistic Language Model, a Disambiguation Model for Chinese word segmentation, or a combination thereof. In some embodiments, the Hidden Markov Model may include a graphical model with weights and a sequence labeling model.

In some embodiments, the first segmenting module 1120 may segment the text based on the phrase list (e.g., the POI phrase list) and obtain the first segmenting result. In some embodiments, the first segmenting result obtained by the first segmenting sequence may be transmitted to the searching module 1130 and used to search for products that the user is interested in.

The searching module 1130 may conduct a search for the text based on the first segmenting result. A segmenting mode may affect a degree representing how the user is interested in the searched products. For example, when the segmenting mode is a fine-grain segmenting mode, the first segmenting result may affect semantic expression of the input text, a portion of the search results may be literally similar to but semantically unrelated with the input text, thereby reducing the degree representing how the user is interested in the searched products. In some embodiments, the products searched by the searching module 1130 may output via the I/O component 260. Information output by the I/O component 260 may include digit, text, voice, image, video, vibration, or the like, or any combination thereof.

FIG. 16 is a flowchart illustrating an exemplary process for searching a query according to some embodiments of the present disclosure. In some embodiments, process 1600 may be implemented as a set of instructions (e.g., an application) stored in the storage ROM 230 or RAM 240. The processor 220, the modules in FIG. 4 and/or the modules in FIG. 15 may execute the set of instructions, and when executing the instructions, the processor 220 and/or the modules may be configured to perform process 1600. The operations of the illustrated process presented below are intended to be illustrative. In some embodiments, process 1600 may be accomplished with one or more additional operations not described and/or without one or more of the operations herein discussed. Additionally, the order in which the operations of the process as illustrated in FIG. 16 and described below is not intended to be limiting.

In 1610, the first obtaining module 1510 may obtain a phrase list. In some embodiments, the phrase list may be predetermined by the query processing system 100 (e.g., the processing engine 112) or a third party. The processing engine 112 may obtain the phrase list from a storage device (e.g., the storage 140) disclosed elsewhere in the present disclosure, the third party (e.g., an external database), etc. In some embodiments, the phrase list may include a set of phrases associated with one or more specific application scenarios. For example, the application scenario may include transportation (e.g., the mobile travel), catering, travelling, medical care, shopping, etc. For example, the phrase list may include a POI phrase list associated with mobile travel. In some embodiments, the phrase list may include a minimum phrase unit and/or a maximum phrase unit.

In 1620, the first obtaining module 1510 may obtain a text input by a user. In some embodiments, the user may input the text via the I/O component 260. For example, the user may input the text through a website or an application. As another example, the user may input the text via a physical interface. An input mode for the text by the user may include a hand-writing input, a mouse input, a touch screen input, a typing input, a sound input, a hand gesture input, an eye movement input, a voice input, etc. The text may be in form of digit, character, voice, picture, video, vibration, or the like, or any combination thereof. The text may include one or more sentences, one or more phrases, one or more phrases, one or more characters, etc. In some embodiments, the text may be associated with one or more products.

In some embodiments, the first obtaining module 1510 may identify the input text based on an image recognition technique and/or a voice recognition technique. For example, an image may be obtained by a camera, and the first obtaining 1510 may identify the input text based on the image recognition technique. As another example, a voice segment may be obtained by a microphone of the user and the first obtaining module 1510 determine the input text based on the voice recognition technique.

In 1630, the first segmenting module 1520 may segment the input text of the user and obtain a first segmenting result. In some embodiments, the first segmenting module 1520 may segment the input text based on a phrase list (e.g., a POI phrase list).

In some embodiments, a segmenting model may include a coarse-grained segmenting mode, a fine-grain segmenting mode, a multi-granularity segmenting mode, or a combination thereof. The fine-grain segmenting mode may refer to segmenting a query into phrases, and each of the phrases may be a phrase unit. The coarse-grain segmenting mode may refer to segmenting a query into phrases, each of the phrases may include one or more phrase units, i.e., a plurality of phrase units may be combined as one phrase and represent a specific entity. In some embodiments, the first segmenting module 1520 may segment the input text based on the fine-grain segmenting mode and obtain a fine-grain segmenting result. In some embodiments, the first segmenting module 1520 may segment the input text based on the coarse-grain segmenting mode and obtain a coarse-grain segmenting result. For example, a fine-grain segmenting result of “Zhe jiang da xue zuo luo zai xi hu pang bian” in Chinese may be “Zhe jiang/da xue/zuo luo/zai/xi hu/pang bian”. A coarse-grain segmenting result of “Zhe jiang da xue zuo luo zai xi hu pang bian” may be “Zhe jiang da xue/zuo luo/zai/xi hu/pang bian”.

In some embodiments, the first segmenting result may include a combination of a plurality of phrases that appear simultaneously with a probability greater than a predetermined threshold. For example, within a time period (e.g., 3 hours), the first segmenting module 1520 may search one or more input texts including “Shu zi” and/or “Zhan bu”, and determine a ratio of a count of input texts including both “Shu zi” and/or “Zhan bu” and a count of input texts within the time period. The first segmenting module 1520 may obtain a probability that “Shu zi” and “Zhan bu” appear simultaneously. When the probability is greater than 70%, “Shu zi” and “Zhan bu” may be regarded as a single phrase “Shu zi zhan bu”. In some embodiments, when two or more phrases appear in historical search records and the phrase list, the two or more phrases may be regard as a single phrase. In different scenarios, the first segmenting module 1520 may use different segmenting modes for segmenting. For example, if the user selects to search the input text accurately, the first segmenting module 1520 may select the coarse-grained segmenting mode.

In 1640, the searching module 1530 may conduct a search for the text based on the first segmenting result. In some embodiments, the segmenting mode may affect a degree representing how the user is interested in the searched products. For example, when the segmenting mode is a fine-grain segmenting mode, the first segmenting result may affect semantic expression of the input text, a portion of the search results may be literally similar to but semantically unrelated with the input text, thereby reducing the degree representing how the user is interested in the searched products. In some embodiments, the product may include a tangible product or an immaterial product. The tangible product may refer to an entity having any shape or any size. For example, the tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include any product that satisfies user demands for information, entertainment, communication, or business. Classification modes of the internet product may be various. Taking a supporting platform as an example, The internet product may include an individual host product, a web product, a mobile internet product, a commercial host product, an embedded product, or the like, or any combination thereof. The internet product may be used in a software, a program, or a system of a mobile terminal. In some embodiments, the product may also include a digital product. The digital product may refer to a product stored in a digitized format, e.g., databases, software, audio products, stock indexes, electronic journals, etc.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

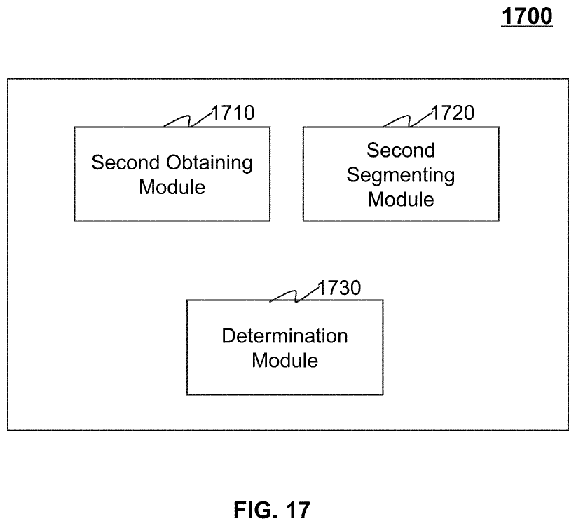

FIG. 17 is a block diagram illustrating an exemplary segmenting device according to some embodiments of the present disclosure. A portion or all of function of modules in the device 1700 may be implemented on the server 110.

The device 1700 may include a second obtaining module 1710, a second segmenting module 1720, and a determination module 1730. Connections between each of the two modules may be wired and/or wireless. Each of the modules may be remote and/or local. A corresponding relationship between each of the two modules may be one-to-one or one-to-many.

The second obtaining module 1710 may obtain data. In some embodiments, the first obtaining module 1110 may obtain the data from the user terminal 130, the storage 130, or the network 120. The data obtained by the first obtaining module may include a phrase model and/or a plurality of training samples. In some embodiments, the data obtained by the second obtaining module 1710 may be transmitted to the second segmenting module 1720. For example, the phrase model and/or the training samples obtained by the second obtaining module 1710 may be transmitted to the second segmenting module 1720. The second segmenting module 1720 may segment the training samples based on the phrase model, and obtain a second segmenting result.

The second segmenting module 1720 may obtain the second segmenting result. In some embodiments, the second segmenting module 1720 may segment each of the training samples and obtain the second segmenting result. In some embodiments, the second segmenting result obtained by the second segmenting module 1720 may be transmitted to the determination module 1730, and used for determine the phrase list (e.g., the POI phrase list).

The determination module 1730 may determine information. The information may include the phrase list (e.g., the POI phrase list). In some embodiments, the POI phrase list may be associated with mobile travel of the users. In some embodiments, the determination module 1730 may transmit the determined information to the first obtaining module 1510, and used to segment the input text.

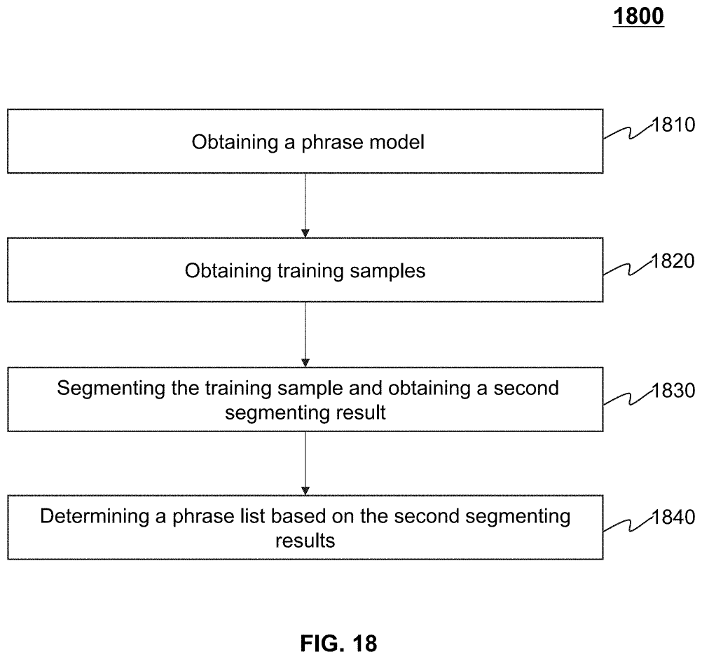

FIG. 18 is a flowchart illustrating an exemplary process for determining a phrase list according to some embodiments of the present disclosure. In some embodiments, process 1800 may be implemented as a set of instructions (e.g., an application) stored in the storage ROM 230 or RAM 240. The processor 220, the modules in FIG. 4 and/or modules in FIG. 17 may execute the set of instructions, and when executing the instructions, the processor 220 and/or the modules may be configured to perform process 600. The operations of the illustrated process presented below are intended to be illustrative. In some embodiments, process 1800 may be accomplished with one or more additional operations not described and/or without one or more of the operations herein discussed. Additionally, the order in which the operations of the process as illustrated in FIG. 18 and described below is not intended to be limiting.

In 1810, the second obtaining module 1710 may obtain a phrase model (also referred to “phrase dictionary” described in FIG. 9). The phrase model may include phrases in various application scenarios. For example, the phrase list may be from and applied in the application scenarios such as a search engine, a shopping web, mobile travel, etc. In some embodiments, the phrase model may include a plurality of sub sets associated with the application scenarios. For example, if one of the application scenarios is vehicle hailing, one of the sub sets may include a phrase list associated with vehicle hailing (also referred to as “POI phrase list”). In some embodiments, phrases may be generated by segmenting second historical search records based on a segmenting technique (e.g., a segmenting model). For example, the segmenting technique may include an N-gram technique, a forward maximum matching technique, a reverse maximum matching technique, a bidirectional maximum matching technique, a minimum matching technique, an optimal matching technique, a hidden Markov model, a maximum entropy model, a conditional random field model, a neural network model, an association-backtracking technique, or the like, or any combination thereof. In some embodiments, a usage frequency of each of the phrases may be determined. The greater a usage frequency of a phrase, the more important the phrase may be. If the usage frequency is greater than a predetermined threshold, the phrase may be added into the phrase dictionary.

In 1820, the second obtaining module 1720 may obtain training samples. Each of the training samples may include a historical input text of a historical user. For example, the historical input text may be “Cheng zuo shun feng the dao zhe jiang da xue” in Chinese. In some embodiments, the second obtaining module 1720 may expand the training samples based on a data smoothing model and a corpus expansion model. The data smoothing model may include a Laplace algorithm, a Good-Turing algorithm, an absolute discount algorithm, a linear discount algorithm, a Witten-Bell algorithm. The corpus expansion model may include synonym expansion and/or phrase class expansion.

In 1830, the second segmenting module 1720 may segment the (expanded) training sample and obtain a second segmenting result. In some embodiments, the second segmenting module 1720 may preliminarily segment each of the (expanded) training sample based on the phrase dictionary and determine one or more preliminary phrases, i.e., the second segmenting result.

In 1840, the determination module 1730 may determine a phrase list based on the second segmenting results. In some embodiments, the phrase list may include phrases associated with one or more application scenarios. For example, the phrase list may include a POI phrase list, and the POI phrase list may be associated with an application scenario of mobile travel. The phrase list may include a minimum phrase unit and/or a maximum phrase unit. Taking the POI phrase list as an example, the determination module 1730 may determine the POI phrase list based on an iteration process. In each iteration, in response to a determination that a second segmenting result satisfies a predetermined rule, the second segmenting result may be added into the phrase dictionary and generate a new phrase dictionary. The determination module 1730 may segment another (expanded) training sample based on the new phrase dictionary. The determination module 1730 may obtain the POI phrase list after the iteration is terminated. As used herein, the predetermined rule may include a usage frequency of a phrase greater than a threshold, a relevance degree of a phrase associated with the mobile travel greater than a threshold.

The usage frequency of the phrase may represent how important the phrase may be. The greater the usage frequency of the phrase is, the more important the phrase may be. In response to a determination that the usage frequency of a phrase is greater than the threshold, the phrase may satisfy the predetermined rule, and the determination module 1730 may add the phrase into the POI phrase list. In some embodiments, the usage frequency of the phrase may refer to a times that the phrase is used within a time period (e.g., within 3 hours). The threshold and the time period may be predetermined. For example, the threshold may be set as 10, and the time period may be set as 24 hours. If a times that “Da che” used within 24 hours is 12, the determination module 1730 may add “Da che” into the POI phrase list. As another example, the threshold may be set as 10, and the time period may be set as 24 hours. If a times that “Jiao che” in Chinese used within 24 hours is 9, the determination module 1730 may not add “Jiao che” into the POI phrase list.

In some embodiments, the determination module 1730 may add new phrases into the POI phrase list. The determination module 1730 may generate the new phrases based on historical search records and/or feature information of phrases.

Each of the historical search records may include a historical query that was input by the historical user for retrieving or a historical retrieving results that was chosen by the historical user.

The feature information of the phrases may include a cohesive parameters of phrases, degrees of freedom of phrases and/or a habit that the user uses the phrases. As used herein, the cohesive parameter may refer to a correlation or a cohesion between at least two phrases, i.e., a probability that the at least two phrases may constitute of a single phrase. The degree of freedom may indicate a probability that at least two phrases appear independently, i.e., a probability that the at least two phrases may not constitute the single phrase. In some embodiments, the cohesive parameter and/or the degree of freedom of the at least two phrases may be determined based on whether the at least two phrases may constitute the single phrase. In some embodiments, one or more input texts including the at least two phrases appearing within a time period (e.g., 3 hours) may be searched. A ratio of a count of input texts including the at least two phrases and a count of input texts within the time period may be determined. A probability that the at least two phrases appear simultaneously may be obtained. When the probability is greater than 60%, the at least two phrases may be regarded as cohesive (i.e., constituting a single phrase). When the probability is smaller than or equal to 40%, the at least two phrases may be regarded as free (i.e., not constituting a single phrase). The habit that the user uses the phrase may refer to that a phrase simultaneously appears in a historical input text and a selected historical search result corresponding to the input text. In some embodiments, the phrase may be added into the phrase list.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a specific feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the specific features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for rewriting a query, comprising:
at least one storage medium including a set of instructions; and
at least one processor in communication with the at least one storage medium, wherein when executing the set of instructions, the at least one processor is directed to:
receive an original query of a user from a user terminal;
segment the original query into one or more original phrases to obtain a phrase sequence;
for each of the one or more original phrases, determine one or more candidate phrases, each of the one or more candidate phrases corresponding to a probability;
for each of the one or more original phrases, determine a rewritten phrase based on the one or more candidate phrases, probabilities corresponding to the one or more candidate phrases, and a predetermined threshold probability; and
generate a rewritten query corresponding to the original query based on rewritten phrases corresponding to the one or more original phrases and the phrase sequence.

2. The system of claim 1, wherein the phrase sequence includes a first original phrase, a second original phrase, . . . , a (j−1)^{th} original phrase, a j^{th} original phrase, . . . , and an N^{th} original phrase, and for each of the one or more original phrases, to determine the one or more candidate phrases and to determine the rewritten phrase, the at least one processor is further directed to:
initiate an iteration process for determining the one or more candidate phrases and determining the rewritten phrase, the iteration process including (N−1) iterations, and each iteration in the iteration process including:
determining one or more (j−1)^{th} candidate phrases for the (j−1)^{th} original phrase and one or more (j−1)^{th} probabilities corresponding to the one or more (j−1)^{th} candidate phrases;
determining a (j−1)^{th} rewritten phrase with a probability greater than the predetermined threshold probability;
determining one or more j^{th} candidate phrases for the ^{jth} original phrase and one or more j^{th} probabilities corresponding to the one or more j^{th} candidate phrases based on the (j−1)^{th} rewritten phrase; and
determining a j^{th} rewritten phrase with a probability greater than the predetermined threshold probability.

3. The system of claim 1, wherein the at least one processor is directed to use a query processing model to determine the one or more candidate phrases and to determine the rewritten phrase, and to determine the query processing model, the at least one processor is directed to perform operations including:
obtaining a plurality of first historical search records, wherein each of the plurality of first historical search records includes a first historical query of a first historical user and a first historical search result selected by the first historical user corresponding to the first historical query;
segmenting each of the plurality of first historical search records; and
training a preliminary query processing model based on the plurality of segmented first historical search records to generate the query processing model.

4. The system of claim 3, wherein the at least one processor is further directed to determine the predetermined threshold probability by:
obtaining a plurality of second historical search records, wherein each of the plurality of second historical search records includes a second historical query of a second historical user and a second historical search result selected by the second historical user corresponding to the second historical query;
for each of the plurality of second historical search records,
obtaining a combination of actual phrases of the second historical record, wherein the combination of the actual phrases includes one or more actual phrases;
determining one or more predicted phrases of each of the one or more actual phrases and one or more predicted probabilities corresponding to the one or more predicted phrases based on the query processing model; and
determining the predetermined threshold probability based on similarity between the actual phrases and the one or more predicted phrases of each of the plurality of second historical records.

5. The system of claim 3, wherein the query processing model includes a sequence to sequence learning model including attention mechanism.

6. A method implemented on a computing device having at least one processor, at least one storage medium, and a communication platform connected to a network, the method comprising:
receiving an original query of a user from a user terminal;
segmenting the original query into one or more original phrases to obtain a phrase sequence;
for each of the one or more original phases, determining one or more candidate phrases, each of the one or more candidate phrases corresponding to a probability;
for each of the one or more original phases, determining a rewritten phrase based on the one or more candidate phrases, probabilities corresponding to the one or more candidate phrases, and a predetermined threshold probability; and
generating a rewritten query corresponding to the original query based on rewritten phrases corresponding to the one or more original phrases and the phrase sequence.

7. The method of claim 6, wherein the phrase sequence includes a first original phrase, a second original phrase, . . . , a (j−1)^{th} original phrase, a j^{th} original phrase, . . . , and an N^{th} original phrase, and for each of the one or more original phrases, the determining the one or more candidate phrases and the determining the rewritten phrase includes:
initiating an iteration process for determining the one or more candidate phrases and determining the rewritten phrase, the iteration process including (N−1) iterations, and each iteration in the iteration process including:
determining one or more (j−1)^{th} candidate phrases for the (j−1)^{th} original phrase and one or more (j−1)^{th} probabilities corresponding to the one or more (j−1)^{th} candidate phrases;
determining a (j−1)^{th} rewritten phrase with a probability greater than the predetermined threshold probability;
determining one or more j^{th} candidate phrases for the ^{jth} original phrase and one or more j^{th} probabilities corresponding to the one or more j^{th} candidate phrases based on the (j−1)^{th} rewritten phrase; and
determining a j^{th} rewritten phrase with a probability greater than the predetermined threshold probability.

8. The method of claim 6, wherein the one or more candidate phrases and the rewritten phrase are determined using a query processing model, and the method further includes determining the query processing model by:
obtaining a plurality of first historical search records, wherein each of the plurality of first historical search records includes a first historical query of a first historical user and a first historical search result selected by the first historical user corresponding to the first historical query;
segmenting each of the plurality of first historical search records; and
training a preliminary query processing model based on the plurality of segmented first historical search records to generate the query processing model.

9. The method of claim 8, wherein the method further includes determining the predetermined threshold probability by:
obtaining a plurality of second historical search records, wherein each of the plurality of second historical search records includes a second historical query of a second historical user and a second historical search result selected by the second historical user corresponding to the second historical query;
for each of the plurality of second historical search records,
obtaining a combination of actual phrases of the second historical record, wherein the combination of the actual phrases includes one or more actual phrases;
determining one or more predicted phrases of each of the one or more actual phrases and one or more predicted probabilities corresponding to the one or more predicted phrases based on the query processing model; and
determining the predetermined threshold probability based on similarity between the actual phrases and the predicted phrases of each of the plurality of second historical records.

10. The method of claim 8, wherein the query processing model includes a sequence to sequence learning model including attention mechanism.

11. A system for retrieving a query, comprising:
at least one storage medium including a set of instructions; and
at least one processor in communication with the at least one storage medium, wherein when executing the set of instructions, the at least one processor is directed to:
obtain a query of a user from a user terminal;
segment the query into one or more phrases based on a phrase list, wherein the phrase list includes a plurality of existing phrases; and
obtain a search result associated with the query by performing a search based on the one or more phrases.

12. The system of claim 11, wherein to segment the query into one or more phrases, the at least one processor is further directed to:
segment the query into the one or more phrases using a coarse-grained segmenting mode or a fine-grained segmenting mode based on the phrase list.

13. The system of claim 11, wherein the at least one processor is further directed to generate the phrase list by:
obtaining a plurality of first historical search records, wherein each of the first historical search records at least includes a first historical query of a first historical user;
segmenting each of the plurality of first historical search records based on a phrase dictionary; and
determining the phrase list based on the segmented first historical search records.

14. The system of claim 13, wherein the at least one processor is further directed to:
initiate an iteration process for determining the phrase list, the iteration process including a plurality of iterations, and each iteration in the iteration process including:
segmenting one first historical search record of the plurality of first historical search records based on the phrase dictionary;
adding the segmented first historical search record to the phrase dictionary to generate a new phrase dictionary in response to a determination that the segmented first historical search record satisfies a predetermined condition; and
segmenting another first historical search record of the plurality of first historical search records based on the new phrase dictionary.

15. The system of claim 11, wherein the at least one processor is further directed to:
obtain a plurality of second historical search records, wherein each of the plurality of second historical search records includes a second historical query of a second historical user or a second historical search result selected by the second historical user corresponding to the second historical search record;
segment each of the plurality of second historical search records;
determine feature information of each of the plurality of segmented second historical search records; and
add at least one phrase among the plurality of segmented second historical search records into the phrase list based on the feature information.

16. The system of claim 15, wherein the feature information includes at least one of: a cohesive parameter between two phrases in the segmented second historical search record, a degree of freedom of a phrase in the segmented second historical search record, and a habit of the user.

17. The system of claim 11, wherein to obtain the search result associated with the query by performing the search based on the one or more phrases, the at least one processor is further directed to:
rewrite the query based on a query processing model, wherein to obtain the query processing model, the at least one processor is directed to perform operations including:
obtaining a plurality of third historical search records, wherein each of the plurality of third historical search records includes a third historical query of a third historical user and a third historical search result selected by the third historical user corresponding to the third historical query;
segmenting each of the plurality of third historical search records; and
training a preliminary query processing model based on the plurality of third segmented historical search records to generate the query processing model.

18-57. (canceled)
